(19) United States
(12) Patent Application Publication
(10) Pub. No.: US 2026/0115063 A1
(43) Pub. Date: Apr. 30, 2026

(54) SEAT SYSTEM

(71) Applicant: Anil Raman PATEL, Birmingham West Midlands (GB)

(72) Inventor: Anil Raman PATEL, Birmingham West Midlands (GB)

(21) Appl. No.: 19/471,724

(22) PCT Filed: Mar. 27, 2024
(86) PCT No.: PCT/GB2024/050827

§ 371 Date: Oct. 2, 2025

(30) Foreign Application Priority Data
Apr. 6, 2023 (GB) 2305145.1
Apr. 6, 2023 (GB) 2305149.3

(51) Int. Cl. A61G 5/10; A61G 5/12

(52) U.S. Cl. CPC A61G 5/1045; A61G 5/1048; A61G 5/1059; A61G 5/1091; A61G 5/124; A61G 5/1062; A61G 5/121

(57) ABSTRACT

A seat system for a wheelchair. The seat system comprises: a left-thigh support comprising an upper-thigh support part and a lower-thigh support part; and a right-thigh support comprising an upper-thigh support part and a lower-thigh support part; wherein the lower-thigh support part of the left-thigh support is separate to the lower-thigh support part of the right-thigh support, and either the upper-thigh support part or the lower-thigh support part of each of the left- and right-thigh supports comprises one or more first engagement members and the other of the upper-thigh support part or the lower-thigh support part of each of the left- and right-thigh supports comprises two or more second engagement members, each of the first engagement members being received or receivable between two of the two or more second engagement members such that the one or more first engagement members and the two or more second engagement members are configured to cooperate with one another in a slidable relationship, such that a length of each of the left- and right-thigh supports is adjustable.

This invention relates generally to a seat system for a wheelchair. More specifically, although not exclusively, this invention relates to a seat system with adaptable thigh supports and/or with an adaptable backrest.

People with postural support needs, either caused by disease or by injury, often require bespoke seats and chairs, such as bespoke wheelchairs. Often a seat system, which is to be fitted to a wheelchair, is adapted to the needs of the user by providing adjustability to a seat pan, a backrest and a headrest of the seat system. People with more complex postural support needs sometimes require further auxiliary components, such as lateral knee and thigh supports, and extra cushion padding to meet the postural support needs of the user. For example, where a user is unable to maintain an upright seating position, extra cushioning may be required on the seat pan to prevent the user's pelvis from moving forwards, and the backrest may need to be adapted to prevent excessive curvature of the spine. In most cases, this results in a bespoke seat system, designed to meet the specific needs of the user. Clearly, such a system is expensive and complex to design. In some cases, the customisation of the seat system also means that the assembly is suboptimal, for example where many individual parts are used, which can lead to parts shifting during use and so no longer meeting the postural support needs of the user.

The expense is exacerbated when the user is a child, as the seat system must be adapted as the child grows, not only to account for increased body size but also because the child's needs are also likely to change as the child grows. This might lead to parts of the seat system needing to be replaced multiple times.

Furthermore, due to the complexity, such systems are bulky and are difficult to assemble. For example, such systems are often difficult to remove from a wheelchair frame, and so this makes transporting such wheelchairs difficult. Also, such systems are often unavailable as standalone systems, and so cannot be fitted to a third-party wheelchair, further increasing the expense of such systems.

It would therefore be advantageous to overcome at least some of these drawbacks.

Accordingly, a first aspect of the invention provides a seat system for a wheelchair, the seat system comprising:
a left-thigh support comprising an upper-thigh support part and a lower-thigh support part; and
a right-thigh support comprising an upper-thigh support part and a lower-thigh support part;
   wherein the lower-thigh support part of the left-thigh support is separate to the lower-thigh support part of the right-thigh support, and either the upper-thigh support part or the lower-thigh support part of each of the left- and right-thigh supports comprises one or more first engagement members and the other of the upper-thigh support part or the lower-thigh support part of each of the left- and right-thigh supports comprises two or more second engagement members, each of the first engagement members being received or receivable between two of the two or more second engagement members such that the one or more first engagement members and the two or more second engagement members are configured to cooperate with one another in a slidable relationship, such that a length of each of the left- and right-thigh supports is adjustable.

As used herein a “member” refers to a feature which extends from a larger structure. For example, in the context of the described seat system each engagement member extends from a main body portion of the respective support part. Advantageously, the length of each of the left- and right-thigh supports may be adapted to the specific needs of a user, and to meet the changing needs of the user. This seat system may be particularly advantageous when it is used by children with postural support needs, as the thigh supports can be adjusted to account for the growth of the child. Further advantageously, by providing the engagement members, the thigh supports may be prevented from rotating during use, providing a more robust seat system.

The one or more first engagement members may be elongate or elongated in shape. The two or more second engagement members may be elongate or elongated in shape. The one or more first engagement members may be coplanar with a part of the respective support part from which it extends. The two or more second engagement members may be coplanar with a part of the respective support part from which they extend. Each of the first engagement members may be received or receivable between two of the two or more second engagement members such that the first and second engagement members may be configured to interdigitate with one another, e.g., in use. The seat system may have a longitudinal direction, corresponding to a forward direction, in use. The one or more first engagement members may extend in the longitudinal direction. The two or more second engagement members may extend in the longitudinal direction. The one or more first engagement members may have the same length as one another. The one or more second engagement members may have the same length as one another.

The seat system for a wheelchair may alternatively be referred to as a wheelchair seat or a wheelchair seat system. Each engagement member may alternatively be referred to as a finger because each one is finger-like in shape.

The seat system may be a postural support seat system for a wheelchair. The seat system may be an adaptable postural support seat system for a wheelchair. The left- and right-thigh support may be configured to be attached or attachable to a seat pan, for example a seat pan which is releasably couplable to a wheelchair frame.

As used herein, ‘upper’ and ‘lower’ may be relative terms, and each upper-thigh support part may support a buttock, in use, and each lower-thigh support part may support a part of an upper thigh, in use.

The engagement members of each upper-thigh support part may be located on a first side of the upper-thigh support part. The engagement members of each lower-thigh support part may be located on a first side of the lower-thigh support part. The one or more first engagement members may extend in a forward or rearward direction, in use. The two or more second engagement members may extend in a forward or rearward direction, in use. The one or more first engagement members may extend in a forward or rearward direction, in use, from a main body part of the respective thigh support part. The two or more second engagement members may extend in a forward or rearward direction, in use, from a main body part of the respective thigh support part.

The one or more first engagement members may be two or more first engagement members and the two or more second engagement members may be three or more second engagement members. Each of the first engagement members may be received or receivable between two of the second engagement members and one of the second engagement members may be received or receivable between two of the first engagement members.

The upper-thigh support of each of the left- and right-thigh supports may comprise the one or more, or two or more, first engagement member/s, and the lower-thigh support of each of the left- and right-thigh supports may comprise the two or more, or three or more, second engagement members. Each of the one or more, or two or more, first engagement member may comprise a channel at a root thereof. Each channel may extend across a width of the respective engagement member. Each channel may be located across a top surface, e.g., a top surface in use, of the respective engagement member. Advantageously, the channels may allow the first engagement members to move up and down more easily. This, in turn, may allow the upper-thigh support parts to be used to develop more complex shapes. Each of the one or more, or two or more, first engagement member may comprise side channels, e.g., which are semi-circular in cross-section, in each side surface, at the root of the respective engagement member. The side channels may allow the first engagement members to move side-to-side more easily. This, in turn, may allow the upper-thigh support parts to be used to develop more complex shapes, in use.

The upper-thigh support part of the left-thigh support may be separate to the upper-thigh support part of the right-thigh support. The upper-thigh support part of each of the left- and right-thigh supports may comprise a curved side which defines a first and second part, respectively, of a periphery of a seat well. The seat well may be configured to receive a buttock-supporting well-insert, in use. The engagement members of each upper-thigh support part may be located on a first side of the upper-thigh support part and the curved side of each upper-thigh support part may be located on a second side of the upper-thigh support part, the second side being opposite to the first side. The seat well may be generally elliptical in plan shape. The curved side of the upper-thigh support part of each of the left- and right-thigh support may be tapered toward the centre of the seat well in a downward direction, when in use. Advantageously, the left- and right-thigh supports may be orientated to account for different amounts of abduction, adduction or wind sweeping of the user's legs, while the curved side of each upper-thigh support part still provides a curved periphery of the seat well. In other words, a buttock-supporting well insert with generally curved sides may still be received in the seat well of the seat system when the orientations of the left- and right-thigh supports are changed. This may be advantageous in combination with the length adjustability provided by the slidable engagement members, because the seat system can be adjusted for pelvic twisting of the user. Thereby, the length of one thigh support may be both extended and rotated to account for such pelvic twisting. Furthermore, in user with postural support needs where legs need to be supported at a non-forward angle, one leg may be of a different length to the other, and so the length adjustability provided by the slidable engagement members, alongside the ability to rotate the thigh supports, may be advantageous.

The seat system may comprise a posterior support, the posterior support comprising a curved side which defines a third part of the periphery of the seat well. The posterior support may comprise a left part and a right part. Each of the left and right parts of the posterior support may comprise a curved side which defines the third part and a fourth part, respectively, of the periphery of the seat well. The posterior support, or the left and right parts of the posterior support, may be configured to be attached or attachable to a seat pan. Advantageously, the left and right parts of the postural support may be positioned as needed to meet the postural support needs of the user, while maintaining generally curved sides of the seat well.

The upper-thigh support part and the lower-thigh support part of each of the left- and right-thigh supports may comprise, or be, foam, i.e., made of foam. The upper-thigh support part and the lower-thigh support part of each of the left- and right-thigh supports may comprise, or be, cushions. The posterior support, for example the left and right parts of the posterior support, may comprise, or be, foam, i.e., made from foam. The posterior support, for example the left and right parts of the posterior support, may comprise, or be, cushions. The foam or cushions may include or be a polystyrene (PS) foam, a polyurethane (PU) foam or an ethylene-vinyl acetate (EVA) foam. The upper-thigh support part and the lower-thigh support part of each of the left- and right-thigh supports, and the posterior support, may comprise a plurality of layers of cushion material. The layers may be stacked in a vertical direction, e.g., in use. Each layer of cushion material may have a different density, stiffness (or elastic modulus) and/or hardness. The cushion material of any one of the layers may comprise, or be, a foam material. The foam material of any one of the layers may comprise, or be, a polystyrene (PS) foam, a polyurethane (PU) foam or an ethylene-vinyl acetate (EVA) foam. There may be three layers of cushion material. Upper and lower layers of the cushion material may be the same material. Each of the upper and lower layer of the cushion material may be thinner than a middle layer, for example less than 50%, less than 40%, less than 30%, less than 20% of the thickness of the middle layer. Upper and lower layers of the cushion material may have a higher density, stiffness (or elastic modulus) and/or hardness than a middle layer of cushion materials. Upper and lower layers of cushion material may comprise, or be, closed-cell, for example Ethylene-vinyl acetate (EVA) foam. The middle layer of cushion material may comprise, or be, open-cell, for example open cell Polyurethane (PU) foam. Advantageously, comfort of the cushions may be increased, because the upper and lower cushion material layers distribute load evenly over the middle cushion material layer, meaning that a lower density foam can be used for the middle cushion material layer. This may also mean that the foam can be selected based on user weight, such that the support part does not completely compress, which may be referred to as “bottoming out”. Furthermore, the use of higher density top and bottom cushion material layers may mean that other components, such as hook and loop fasteners, can be glued to the outer surfaces of the support part to allow other accessories to be attached to the support part to construct seat for more complex user needs. Further still, this may also mean that the upper and lower surfaces of the support part are more resilient to damage, and so may improve the longevity of the support part. The lower, middle and upper layers of cushion material layer may be referred to as first, second and third layers, respectively.

The upper-thigh support part and the lower-thigh support part of each of the left- and right-thigh supports, and the posterior support, may comprise or may be formed of, a lattice structure. for example a polymeric or plastics lattice structure. The lattice structure may comprise a plurality of struts connected together, at each end, by nodes. The lattice structure may be produced by 3D printing. The lattice structure may be formed using an elastomeric material, such as elastomeric polyurethan (EPU) or silicone. A density and/or stiffness (i.e., elastic modulus) of the lattice structure may vary with location in the respective part. The density and/or stiffness of the lattice structure may be bespoke to a user. Advantageously the lattice structure may improve airflow therethrough for heating and/or cooling. Further advantageously, the ability to vary the density and/or stiffness may enable the parts to relieve pressure concentrations for the user.

The curved side or sides of the posterior support may be tapered toward the centre of the seat well in a downward direction, when in use.

The seat system may comprise one or more lateral trochanter support parts attached or attachable to the posterior support and/or to the upper-thigh support parts. The seat system may comprise one or more lateral thigh support parts which are attached or attachable to the lower-thigh support parts. The seat system may comprise one or more medial thigh support parts which are attached or attachable to the lower-thigh support parts.

The seat system may comprise a buttock-supporting well-insert. The buttock-support well-insert may comprise a tapered side. The tapered side may be, for example, configured to correspond to the tapered sides of the seat well. The buttock-supporting well-insert may be generally elliptical in plan view. The buttock-supporting well insert may comprise, or be, one of or any combination of: a foam cushion, e.g., a viscoelastic foam cushion, a gel cushion, an additively manufactured porous structure and a polymeric lattice structure.

The buttock-supporting well-insert may comprise an inflatable bladder, an air-hose in fluidic communication with the bladder, and a valve in fluidic communication with the air hose for selectively inflating or deflating the bladder. The buttock-supporting well insert may comprise a left inflatable bladder, a right inflatable bladder, a left air-hose in fluidic communication with the left inflatable bladder, a right air-hose in fluidic communication with the right inflatable bladder, and a valve in fluidic communication with each of the left and right air-hoses for selectively inflating and deflating the respective bladder. The, or each, inflatable bladder may be inflatable by a hand pump or by an electronic pump connected to a microcontroller. Advantageously, the seat system may be adjustable to account for various levels of pelvic tilt by changing the air pressure in the, or each, inflatable bladder.

The buttock-supporting well-insert may comprise a bladder which includes, for example is substantially filled with, microbeads. The buttock-supporting well-insert may comprise a valve in fluidic communication with the bladder for selectively evacuating air from the bladder, for example to hold the bladder under a vacuum pressure. Advantageously, air can be evacuated from the bladder, through the valve, such that the microbeads may be held in a moulded shape which is specifically suited to the wheelchair user's needs.

The engagement members of each upper-thigh support part may be located on a first side of the upper-thigh support part. A second side of each upper-thigh support part, which is opposite to the first side, may be tapered in a direction away from the first side and in a downward direction, when in use on the wheelchair.

The seat system may comprise a left-buttock support and a right-buttock support. The left- and right-buttock supports may be located rearward of the left- and right-thigh supports, in use. The height and/or orientation, relative to the left- and right-thigh supports, of each of the left- and right-buttock supports may be adjustable, for example independently adjustable, in use. Advantageously, the seat system may therefore be adjustable to account for various levels of pelvis tilt.

The upper-thigh support part of each of the left- and right-thigh supports, and the lower-thigh support part of each of the left- and right-thigh supports, may comprise, or be, a cushion. The cushions may include or be a polystyrene (PS) foam, a polyurethane (PU) foam, or an ethylene-vinyl acetate (EVA) foam. Each of the left- and right-thigh supports, and the lower-thigh support part of each of the left- and right-thigh supports, may comprise a plurality of layers of cushion material. The layers may be stacked in a vertical direction, e.g., in use. Each layer of cushion material may have a different density, stiffness (or elastic modulus) and/or hardness. The cushion material of any one of the layers may comprise, or be, a foam material. The foam material of any one of the layers may comprise, or be, a polystyrene (PS) foam, a polyurethane (PU) foam or an ethylene-vinyl acetate (EVA) foam. There may be three layers of cushion material. Upper and lower layers of the cushion material may be the same material. Upper and lower layers of the cushion material may have a higher density, stiffness (or elastic modulus) and/or hardness than a middle layer of cushion material. Each of the upper and lower layer of the cushion material may be thinner than the middle layer, for example less than 50%, less than 40%, less than 30%, less than 20% of the thickness of the middle layer. Upper and lower layers of cushion material may comprise, or be, closed-cell, for example Ethylene-vinyl acetate (EVA) foam. The middle layer of cushion material may comprise, or be, open-cell, for example open cell Polyurethane (PU) foam. Advantageously, comfort of the cushions may be increased, because the upper and lower cushion material layers distribute load evenly over the middle cushion material layer, meaning that a lower density foam can be used for the middle cushion material layer. This may also mean that the foam can be selected based on user weight, such that the support part does not completely compress, which may be referred to as “bottoming out”. Furthermore, the use of higher density top and bottom cushion material layers may mean that other components, such as hook and loop fasteners, can be glued to the outer surfaces of the support part to allow other accessories to be attached to the support part to construct seat for more complex user needs. Further still, this may also mean that the upper and lower surfaces of the support part are more resilient to damage, and so may improve the longevity of the support part. The lower, middle and upper layers of cushion material layer may be referred to as first, second and third layers, respectively.

Each of the left- and right-thigh supports, and the lower-thigh support part of each of the left- and right-thigh supports, may comprise or may be formed of, a lattice structure, for example a polymeric or plastics lattice structure. The lattice structure may comprise a plurality of struts connected together, at each end, by nodes. The lattice structure may be produced by 3D printing. The lattice structure may be formed using an elastomeric material, such as elastomeric polyurethan (EPU) or silicone. A density and/or stiffness (i.e., elastic modulus) of the lattice structure may vary with location in the respective part. The density and/or stiffness of the lattice structure may be bespoke to a user. Advantageously the lattice structure may improve airflow therethrough for heating and/or cooling. Further advantageously, the ability to vary the density and/or stiffness may enable the parts to relieve pressure concentrations for the user.

The seat system may comprise a seat pan. The seat system may comprise a seat pan to which the upper-thigh support part and the lower-thigh support part of each of the left and right-thigh supports are attached or attachable. The posterior support, or the left and right parts of the posterior support may be attached or attachable to the seat pan. The buttock-supporting well-insert may sit atop the seat pan, in use.

The seat system may comprise a base panel. The posterior support, or the left and right parts of the posterior support, may be attached or attachable to the base panel. The base panel may be attached or attachable to the seat pan. The base panel may be, or may comprise, a cushion, for example a foam cushion. The base panel may comprise, or may be, a cushion made of a plurality of layers of cushion material. The layers of cushion material may be as described previously.

The base panel may comprise:
a left base panel support comprising an upper base panel support part and a lower base panel support part; and
a right base panel support comprising an upper base panel support part and a lower base panel support part;
   wherein the lower base panel support part of the left base panel support is separate to the lower base panel support part of the right base panel support, and either the upper base panel support part or the lower base panel support part of each of the left and right base panel supports comprises one or more third engagement members, and the other of the upper base panel support part or the lower base panel support part of each of the left and right base panel supports comprises two or more fourth engagement members, each of the third engagement members being received or receivable between two of the two or more fourth engagement members such that the one or more third engagement members and the two or more fourth engagement members are configured to cooperate with one another in a slidable relationship, such that a length of each of the left and right base panel supports is adjustable.

As used herein a “member” refers to a feature which extends from a larger structure. For example, in the context of the described seat system each engagement member extends from a main body portion of the respective base panel support.

The one or more third engagement members may be elongate or elongated in shape. The two or more fourth engagement members may be elongate or elongated in shape. The one or more third engagement members may be coplanar with a part of a respective part of the support part from which they extend. The two or more fourth engagement members may be coplanar with a part of the respective support part from which they extend. Each of the third engagement members may be received or receivable between two of the two or more fourth engagement members such that the third and fourth engagement members may be configured to interdigitate with one another, e.g., in use. The engagement members of each upper base panel support part may be located on a first side of the upper base panel support part. The engagement members of each lower base panel support part may be located on a first side of the lower base panel support part. The one or more third engagement members may extend in a forward or rearward direction, in use. The two or more fourth engagement members may extend in a forward or rearward direction, in use. The one or more third engagement members may extend in a forward or rearward direction, in use, from a main body part of the respective base panel support part. The two or more fourth engagement members may extend in a forward or rearward direction, in use, from a main body part of the respective base panel support part. Advantageously, the length, in a forward to rearward direction, of the seat well may be adjustable. This may be beneficial both for accommodating different sizes of user, but also to accommodate different buttock seating positions. The seat system may comprise one or more wedges located beneath one or both thigh support part, in use. The one or more wedges may provide tilting of the respective thigh support part. The one or more wedges may be attached or attachable to the seat pan.

The seat pan may comprise a left lower-thigh support plate, a right lower-thigh support plate and a main support plate. The left and right lower-thigh support plates may be movably mounted to the main support plate such that the orientation, and the position in the forward direction when in use, of each of the left and right lower-thigh support plates is independently adjustable relative to the main support plate. The lower-thigh support parts of each of the left- and right-thigh supports may be attached or attachable to the respective left and right lower-thigh support plate. The upper-thigh support parts may be attached or attachable to the main support plate.

Each lower-thigh support plate may be connected to the main plate via a connection member, each connection member being fixed relative to the respective lower-thigh support plate, and each connection member comprising two slide pins. A first slide pin may be receivable in a respective straight slot in the main support plate, for allowing the connection member to move in a forward direction, in use. A second slide pin may be receivable in a respective arc slot in the main support plate, to allow the respective connection member to be rotated about the first slide pin, in use.

The seat pan may comprise coupling means for releasably coupling the seat pan to a wheelchair. The coupling means may comprise four coupling mechanisms, each coupling mechanism being independently adjustable in a height direction to adjust any number of the height, inclination, e.g., pitch, e.g., about a horizontal axis, and lateral tilt, e.g., roll, e.g. about a vertical axis, of the seat pan relative to the wheelchair, in use.

The coupling means may comprise two front rods and two rear rods, each front rod extending in a respective lateral direction from the seat pan, and each rear rod extending in a respective lateral direction from the seat pan. The coupling means may also comprise two front clamps and two rear clamps. The front and rear clamps may be attached or attachable to a frame of the wheelchair, for example each of the rear clamps comprising an overhang for receiving the rear rods extending from the seat pan, and each of the front clamps comprising a latch for releasably securing the front rods to the front clamps. Advantageously, the seat pan can be slid into the rear clamps and then secured into the front clamps in separate movements, simplifying assembly and disassembly of the seat pan to the wheelchair.

The latch of each of the front clamps may have an open configuration whereby the respective front rod is insertable into and removable from the latch, and a closed configuration whereby the respective front rod is securable in the latch. Each rod may comprise a locking cavity along a side thereof. Each latch may comprise:
a biasing member, e.g., a spring, which is configured to urge the latch into the closed configuration;
a locking protrusion protruding from the latch, the locking protrusion being configured to enter into the locking cavity of the respective front rod when the latch is rotated into the open configuration, to secure the latch in the open configuration against a biasing force of the biasing member.

The biasing member may be configured to return the latch to the closed configuration when the rod is removed from the respective latch, i.e., due to the locking protrusion being removed from the respective locking cavity and thereby allowing the biasing force of the spring to urge the latch into the closed configuration.

Each of the front and rear rods may comprise a lateral support bar extending across a width direction of a lower surface of the seat pan, in use. Each of the front and rear rods may comprise a lateral support bar extending across a width direction of the connection member connecting each of a left lower-thigh support plate and a right lower-thigh support plate to a main support plate, in use.

The seat system may comprise a backrest which is releasably attachable to the wheelchair independently of the seat pan.

Another aspect of the invention provides a seat system for a wheelchair, the seat system comprising:
a left-thigh support comprising an upper-thigh support part and a lower-thigh support part; and
a right-thigh support comprising an upper-thigh support part and a lower-thigh support part;
   wherein the lower-thigh support part of the left-thigh support is separate to the lower-thigh support part of the right-thigh support, and wherein each of the upper- and lower-thigh support parts of the left- and right-thigh supports comprises, or is formed of, a lattice structure. The lattice structure may be any of the aforementioned lattice structures.

Another aspect of the invention provides a method of designing a seat system for a wheelchair. A first step of the method may comprise determining one or more postural support need of the user, for example by determining a pressure distribution map which will be applied to the seating system, by the user, in use. The method may comprise designing a lattice structure to alleviate pressure concentrations. This may be to more evenly distribute the pressure over the seating system. This may include determining a distribution of density and/or stiffness (e.g. elastic modulus) of the seating system. The method may comprise 3D printing the seating system, using the designed lattice structure.

According to a further aspect of the invention, there is provided a wheelchair seat comprising one of the aforementioned seat systems.

According to another aspect of the invention there is provided a wheelchair comprising one of the aforementioned seat systems.

According to a further aspect of the invention there is provided a buttock-support well-insert for example for insertion into the seat well of the aforementioned seat system. The buttock-supporting well-insert may comprise a substantially air-tight bladder and a valve in fluidic communication with the bladder and configured to selectively permit air to enter or exit the bladder.

The bladder may be an inflatable bladder, the buttock-supporting well-insert may comprise an air-hose in fluidic communication with the bladder, and the valve may be in fluidic communication with the air hose for selectively inflating or deflating the bladder.

The buttock-supporting well insert may comprise a left inflatable bladder, a right inflatable bladder, a left air-hose in fluidic communication with the left inflatable bladder, a right air-hose in fluidic communication with the right inflatable bladder, and a valve in fluidic communication with each of the left and right air-hoses for selectively inflating and deflating the respective bladder. The buttock-supporting well-insert may comprise a channel extending along a top surface thereof, between the left and right inflatable bladders.

The bladder may include, for example be substantially filled with, microbeads. The valve may be in fluidic communication with the bladder for selectively evacuating air from the bladder, for example to hold the bladder under a vacuum pressure. Advantageously, air can be evacuated from the bladder, through the valve, such that the microbeads may be held in a moulded shape which is specifically suited to the wheelchair user's needs.

The buttock-supporting well-insert may comprise multiple layers of different materials. The materials may have different densities and/or different stiffnesses. The top layer may comprise viscoelastic foam. The buttock-supporting well-insert may comprise one or more cavities, each for receiving a stiffener. The buttock-support well-insert may comprise the one or more stiffener. The one or more inflatable bladders may each be received in a respective one of the cavities. The one or more cavity may be open at a bottom of the buttock-supporting well-insert and may be a blind cavity.

The buttock-supporting well-insert may comprise a lattice structure. The lattice structure may be additively manufactured, for example 3D printed using plastic. The density and/or stiffness of the lattice structure may vary across any direction of the lattice structure, for example, the stiffness may increase in a downwards direction, when the well-insert is in use.

According to another aspect of the invention there is provided a coupling means for releasably coupling the seat pan to a wheelchair. The coupling means may comprise four coupling mechanisms, each coupling mechanism being independently adjustable in a height direction to adjust any number of the height, inclination, e.g., pitch, e.g., about a horizontal axis, and lateral tilt, e.g., roll, e.g., about a vertical axis, of the seat pan relative to the wheelchair, in use.

The coupling means may comprise two front rods and two rear rods, each front rod extending in a respective lateral direction from the seat pan, and each rear rod extending in a respective lateral direction from the seat pan. The coupling means may also comprise two front clamps and two rear clamps, the front and rear clamps being attached or attachable to a frame of the wheelchair. Each of the rear clamps may comprise an overhang for receiving the rear rods extending from the seat pan. Each of the front clamps may comprise a latch for releasably securing the front rods to the front clamps.

The latch of each of the front clamps may have an open configuration whereby the respective front rod is insertable into and removable from the latch, and a closed configuration whereby the respective front rod is secured in the latch. Each rod may comprise a locking cavity along a side thereof. Each latch may comprise:
a biasing member which is configured to urge the latch into the closed configuration; and
a locking protrusion protruding from the latch, the locking protrusion being configured to enter into the locking cavity of the respective front rod when the latch is rotated into the open configuration, to secure the latch in the open configuration against a biasing force of the biasing member.

The biasing member may be configured to return the latch to the closed configuration when the rod is removed from the respective latch, i.e., due to the locking protrusion being removed from the respective locking cavity and thereby allowing the biasing force of the spring to urge the latch into the closed configuration.

According to another aspect of the invention there is provided a back support system for a wheelchair, the back support system comprising:
a backrest comprising:
   a rear surface configured to face away from the user, in use;
   an aperture extending through the backrest;
an attachment surface extending, e.g., configured to extend, from the rear surface of the backrest, the attachment surface extending, e.g., configured to extend, across, or along a side of, the aperture;
   wherein the attachment surface is for attaching one or more backrest contouring accessories to the backrest, e.g., for inserting a part of one or more backrest contouring accessory through the aperture for attachment to the attachment surface.

According to another aspect of the invention there is provided a back support system for a wheelchair, the back support system comprising:
a backrest comprising:
   a rear surface configured to face away from the user, in use;
   a height defining a height direction;
   an aperture extending through the backrest; and
   an attachment surface extending, e.g., configured to extend, from the rear surface of the backrest and orientated, e.g., configured to be orientated, along the height direction of the backrest, the attachment surface extending, e.g., configured to extend, across, or along a side of, the aperture;
wherein the attachment surface is for attaching one or more backrest contouring accessories to the backrest, e.g., for inserting a part of one or more backrest contouring accessory through the aperture for attachment to the attachment surface.

Advantageously, one or more backrest contouring accessory is insertable through the aperture and securable to the attachment surface, meaning that access to securing means (e.g. bolts or screws) for attaching the backrest contouring accessory is easily available, as the back of the backrest is typically not covered by cushions.

The attachment surface may extend in a rearward direction, e.g., in use. The attachment surface may extend orthogonally to the rear surface. The attachment surface may adjoin, abut, or be adjacent to, the rear surface. The back support system may be a postural back support system for a wheelchair. The back support system may be an adaptable postural back support system for a wheelchair. The back support system for a wheelchair may alternatively be referred to as a wheelchair back support or a wheelchair back support system.

The back support system may comprise two attachment surfaces extending, e.g., configured to extend, from the rear surface of the backrest and orientated, e.g., configured to be orientated, along the height direction of the backrest, each attachment surface extending, e.g., configured to extend, across, or along a side of, the aperture, wherein the attachment surfaces are for attaching one or more backrest contouring accessory. The aperture may be located substantially centrally relative to a width of the backrest. The or each attachment surface may extend from, e.g., be configured to extend from, either directly, e.g., as a unitary component, or indirectly, e.g., from an additional component, e.g., an attachment bar which is attached or attachable to the backrest.

The aperture may have a first side and a second side which is opposite to the first side, the first side and the second side each being substantially orientated along the height direction of the backrest. Each attachment surface may be a surface of an attachment plate. One of the attachment plates may extend from each of the first side and the second side of the aperture.

The aperture may be an elongate aperture and the first and second sides may be longer sides of the elongate aperture. The aperture may extend over more than 25% of the height of the backrest, for example more than 20% of the height, for example more than 30% or more than 40% of the height of the backrest. The aperture may be located closer to a bottom of the backrest than the top of the backrest. A depth of each attachment plate may be less than or equal to half of a width of the aperture.

The backrest may comprise, or may be, a plate. The backrest may have a bending stiffness or bending rigidity, i.e., the backrest may not act as a membrane. The attachment plates and the remainder of the backrest may be unitary, for example comprising a metal plate, a metal alloy plate, a mild steel plate, a plastic plate or a composite plate. Advantageously, when the backrest comprises a metal plate the backrest may be produced from a single sheet and the attachment plates bent into the direction away from the wheelchair user.

The attachment surfaces may be opposing surfaces of an attachment bar which is attached or attachable to the rear surface of the backrest at a position which is located substantially centrally relative to the width of aperture. The attachment bar may be located substantially centrally relative to the width of the backrest.

Each attachment surface or attachment plate may comprise at least one channel or a row of spaced apart holes along the respective attachment surface. The at least one channel or row of spaced apart holes may extend through the respective attachment plate. The at least one channel or row of spaced apart holes may be for inserting one or more fasteners through, for attaching the one or more backrest contouring accessory. The at least one channel or a row of spaced apart holes may be substantially aligned with the height direction of the backrest. Advantageously, the one or more backrest contouring accessory may be attached to the backrest at any position along the length of the attachment surface or attachment surfaces.

The backrest may comprise a central portion through which the aperture is located, and two side portions which extend in a forward direction, in use, at an oblique angle to the central portion. The oblique angle may be less than 20°, for example 15° or 10°.

The backrest may comprise a channel and/or a row of spaced-apart holes extending through the backrest, and located proximal each side, or in each side portion, of the backrest and substantially aligned with the height direction. Each channel or row of spaced-apart holes may be for attaching one or more lateral trunk supports and/or coupling means to the backrest.

The back support system may comprise one or more lateral trunk supports attached or attachable to each channel or to each row of spaced-apart holes. Each lateral trunk support may comprise a connecting arm, the connecting arm comprising a first portion connected to a second portion via two indexing discs. Each indexing disc may comprise teeth on one of the faces, which are configured to engage with teeth on a face of the second indexing disc. In this way, the two indexing discs may be securable to one another in discrete rotational increments. The orientation of the first portion relative to the second portion may be set by rotating one indexing disc relative to the other indexing disc and then securing the indexing discs together in an engaged configuration. The indexing discs may provide rotational increments of 10°. The indexing disc may also be referred to as a Hirth disc, Hirth joint or Hirth coupling.

The back support system may comprise coupling means for releasably coupling the backrest to the wheelchair. The coupling means may comprise a plurality of, for example four, coupling mechanisms connected or connectable to the backrest. Each coupling mechanism may provide adjustment of the backrest in a direction normal to the connection between the backrest and the respective coupling mechanism such that any number of a forward position with respect to the wheelchair in use, rotation about a height direction or rotation about a width direction, is adjustable. Advantageously, the position and orientation of the backrest may be adapted to meet the needs of the user.

The coupling means may comprise a clamp assembly associated with each coupling mechanism, for example four clamp assemblies. Each clamp assembly may be attached or attachable to a frame of the wheelchair. Each clamp assembly may comprise a latch. The coupling means may comprise four rods attached or attachable to the backrest, each rod being configured to engage with a respective one of the latches to removably secure the backrest to the frame of the wheelchair.

Each of the four latches may comprise an open-ended channel, each open-ended channel for receiving the respective rod therein. Each latch may comprise a securing pin or gate pin for releasably securing the respective rod in the channel.

Two of the four latches may be upper latches, when attached to the wheelchair, and two of the four latches may be lower latches, when attached to the wheelchair. The channel of each upper latch may be orientated such that the respective rod is insertable into the open end in a substantially downward direction, in use. The channel in each lower latch may be orientated such that the respective rod is insertable into the open end in a substantially horizontal direction, in use. Advantageously, the backrest may be inserted into the upper latches first, and then the position of the lower latches can be set, by securing the associated clamping mechanism, without a user needing to support the full weight of the backrest.

The coupling means may comprise angled brackets, each angled bracket configured to connect one of the rods to the backrest. Each angled bracket may comprise a first portion at an oblique angle to a second portion, each of the first and second portions having a channel or a row of spaced holes extending partway along the length thereof, for attaching the first portion to the backrest at various positions along the length of the first portion, and for attaching the respective rod to the second portion at various positions along the length of the second portion. Advantageously, this may allow the height, lateral position, or rotation of the backrest, with respect to the wheelchair, to be adjusted.

The back support system may comprise a sacral support which is attached or attachable to the backrest. The sacral support may be configured to extend beyond a lower edge of the backrest, in use. The position in the height direction relative to the backrest, and/or the orientation relative to the backrest, may be adjustable when the sacral support is attached to the backrest.

The back support system may comprise one or more sacral support bladder attached or attachable to the sacral support, the one or more sacral support bladder comprising an air-hose wherein, when the sacral support bladder is attached to the sacral support, and the sacral support is attached to the backrest, the air-hose is threaded through the aperture of the backrest.

The back support system may comprise two sacral support attachment plates which are attached or attachable to the sacral support in a spaced relationship, such that a part of the backrest is receivable between the sacral support attachment plates and the sacral support. Each sacral support attachment plate may comprise one or more channels or a plurality of spaced apart holes for attaching the sacral support attachment plate to the backrest at a plurality of positions and orientations.

Each sacral support attachment plate may comprise a connection plate extending in a direction away from the wheelchair user, in use. The back support system may comprise a U-shaped sacral connector having a central portion and two side portions extending from either side of the central portion, the central portion being connectable to the sacral support and each side portion being insertable between, and connected to, the connection plates of the sacral support attachment plates. The connection plate of each sacral support attachment plate and/or each side portion of the sacral connector may comprise one or more channels or a plurality of spaced apart holes, for adjusting any number of a forward position in use, or a tilt of the sacral support, about a width direction of the backrest, relative to the backrest.

The back support system may comprise a shoulder support which is attached or attachable to the backrest and which is configured to extend above an upper edge of the backrest, in use. The position in the height direction relative to the backrest, and/or the orientation relative to the backrest, may be adjustable when the shoulder support is attached to the backrest.

The back support system may comprise a shoulder support attachment plate which is attachable to the shoulder support and which comprises a channel or a plurality of spaced apart holes for attaching the shoulder support to the backrest at a plurality of positions and/or orientations.

The back support system may comprise a headrest attached or attachable to the shoulder support. A position and/or orientation of the headrest, relative to the shoulder support, may be adjustable when the headrest is attached to the shoulder support.

According to another aspect of the invention there is provided a seat system comprising the aforementioned back support system and a seat pan which is releasably attachable to the wheelchair independently of the backrest. The seat system may comprise one of the aforementioned seat systems. The seat system may comprise the aforementioned buttock-supporting well-insert.

According to another aspect of the invention there is provided a wheelchair seat comprising the aforementioned back support system.

According to another aspect of the invention there is provided a wheelchair comprising the aforementioned back support system.

According to another aspect of the invention there is provided a backrest contouring accessory, for example for attachment to the aforementioned back support system, the backrest contouring accessory comprising:
a user-facing portion configured to be located between a wheelchair user and the backrest, in use; and
an accessory attachment plate extending from the user-facing portion and configured to be inserted through the aperture of the backrest and attached to the, or one of the, attachment surfaces.

The user-facing portion of the backrest contouring accessory may comprise a connection slot, and may be connected or connectable to the accessory attachment plate via a rotatable connector. The rotatable connector may comprise:
a first connector comprising an open-topped, semi-spherical shell with a connecting portion extending laterally from a periphery of the semi-spherical shell;
a second connector received or receivable in the connection slot of the user-facing portion, the connecting portion of the first connector being connected or connectable to the second connector such that the position of the first connector with respect to the user-facing portion is adjustable along a length of the connection slot, in use;
a third connector which is semi-spherical in shape and comprises an connector extrusion protruding from an apex of the semi-spherical shape, the third connecter being received or receivable inside of the semi-spherical shell of the first connector with the connector extrusion extending through the open-top of the semi-spherical shell;
   wherein the accessory attachment plate has a semi-spherical cavity in which the semi-spherical shell of the first connector is received or is receivable, such that the connector extrusion of the third connector is configured to abut an inner surface of, and be connected to, the semi-spherical cavity of the accessory attachment plate.

The user-facing portion of the backrest contouring accessory may be configured to be mouldable or bendable. Advantageously, this may provide further adaptability to the back support system. The backrest contouring accessory, or the user facing portion of the backrest contouring accessory, may comprise aluminium or an aluminium alloy.

The backrest contouring accessory may comprise attachment plates extending from the user-facing portion, each attachment plate configured to be inserted through the aperture of the backrest and attached to a respective one of the attachment surfaces of the backrest.

The backrest contouring accessory may be a lumber support accessory.

The attachment plate of the contouring accessory may be located at an end of the user-facing portion. The backrest contouring accessory may be a rib support.

According to another aspect of the invention there is provided the aforementioned back support system comprising one or more of the aforementioned backrest contouring accessory.

According to another aspect of the invention there is provided a method of manufacturing the backrest of the aforementioned back support system, the method comprising cutting an outline of the aperture and of the attachment plates in a sheet material and bending the attachment plates into the direction which is away from a wheelchair user, in use.

Within the scope of this application it is expressly intended that the various aspects, embodiments, examples and alternatives set out in the preceding paragraphs, in the claims and/or in the following description and drawings, and in particular the individual features thereof, may be taken independently or in any combination. That is, all embodiments and/or features of any embodiment can be combined in any way and/or combination, unless such features are incompatible. For the avoidance of doubt, the terms “may”, “and/or”, “e.g.”, “for example” and any similar term as used herein should be interpreted as non-limiting such that any feature so-described need not be present. Indeed, any combination of optional features is expressly envisaged without departing from the scope of the invention, whether or not these are expressly claimed. The applicant reserves the right to change any originally filed claim or file any new claim accordingly, including the right to amend any originally filed claim to depend from and/or incorporate any feature of any other claim although not originally claimed in that manner.

Embodiments of the invention will now be described by way of example only with reference to the accompanying drawings in which:

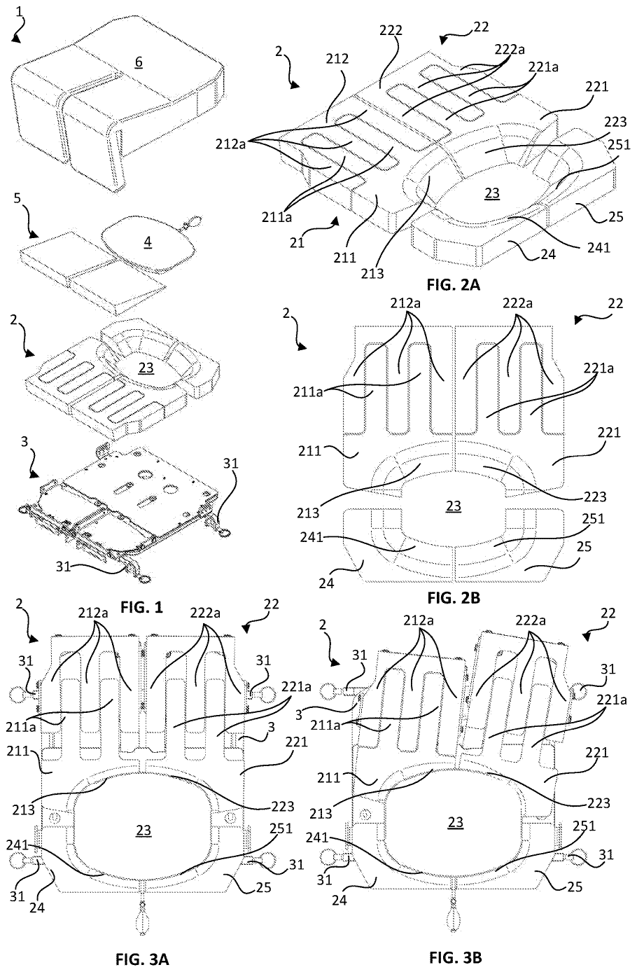

FIG. 1 is an exploded view of a seat system with a first example of a seat pan, a core, postural support accessories and a covering;

FIGS. 2A-2B are views of a core of the seat system of FIG. 1.

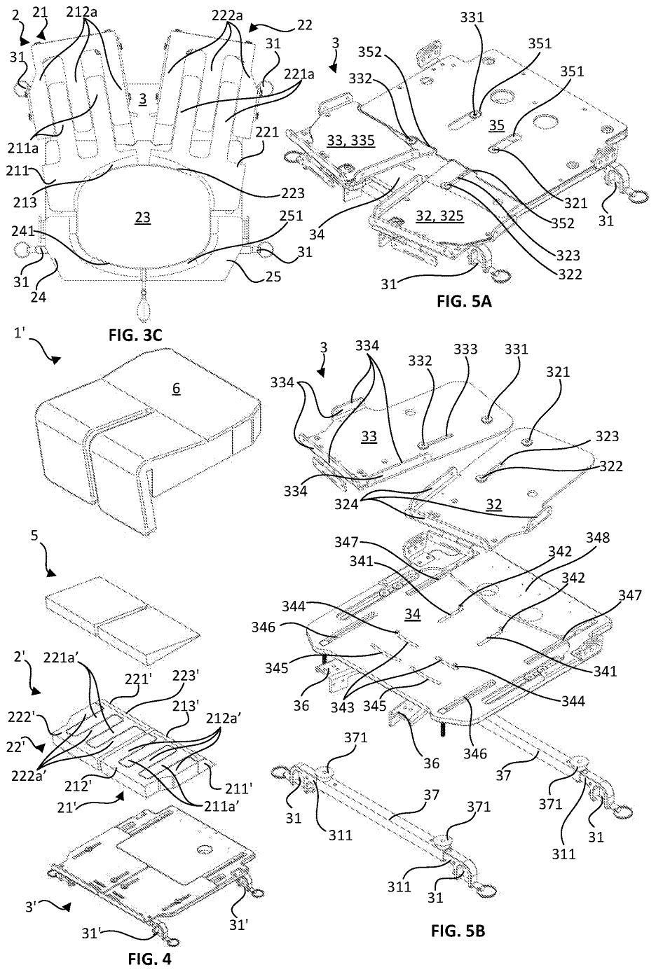

FIGS. 3A-3C are views of a core and seat pan of the seat system of FIG. 1;

FIG. 4 is an exploded view of a seat system with a second example of a core;

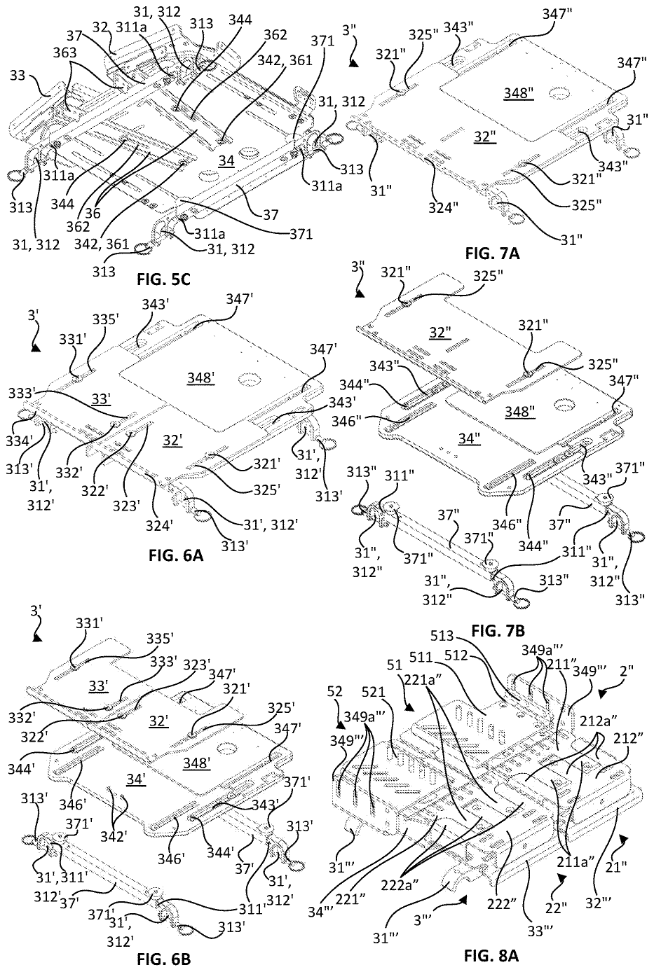

FIGS. 5A-5C are views of a first example of a seat pan;

FIGS. 6A-6B are views of a second example of a seat pan;

FIGS. 7A-7B are views of a third example of a seat pan;

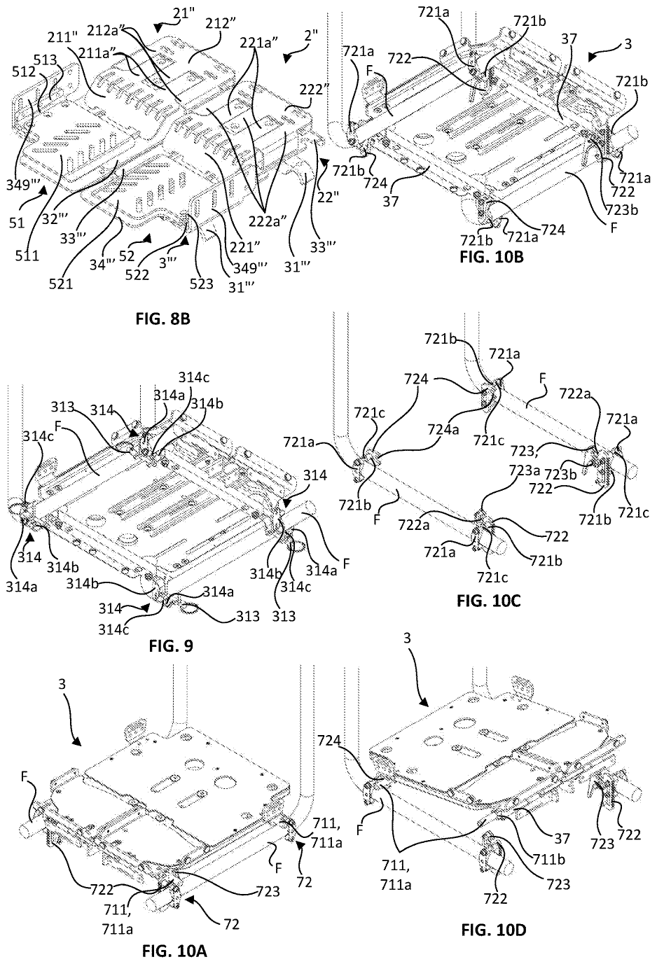

FIGS. 8A-8B are views of a third example of a core and an associated fourth example of a seat pan;

FIG. 9 is a view of a first example of coupling means for attaching a seat pan to a wheelchair;

FIGS. 10A-10D are views of a second example of coupling means for attaching a seat pan to a wheelchair;

FIGS. 11A-11B are views of the coupling means of FIG. 10;

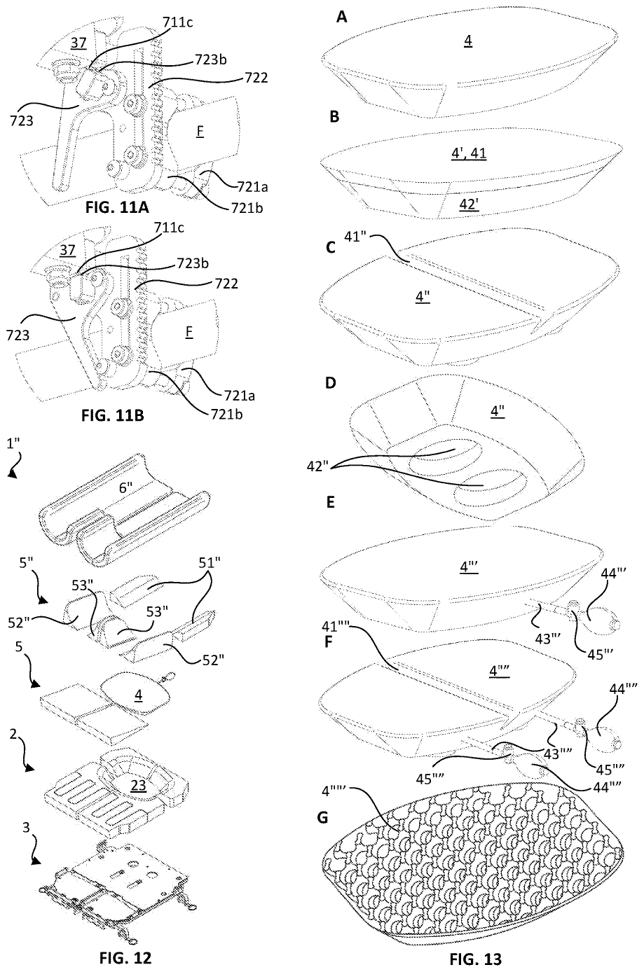

FIG. 12 is an exploded view of a seat system with the first example of the core, seat pan and postural support accessories, with further postural support accessories and a second example of a covering;

FIGS. 13A-13G are views of various examples of buttock-supporting well inserts, for use with the first example of the core;

FIGS. 14A-14B are views of a first example of a back support system;

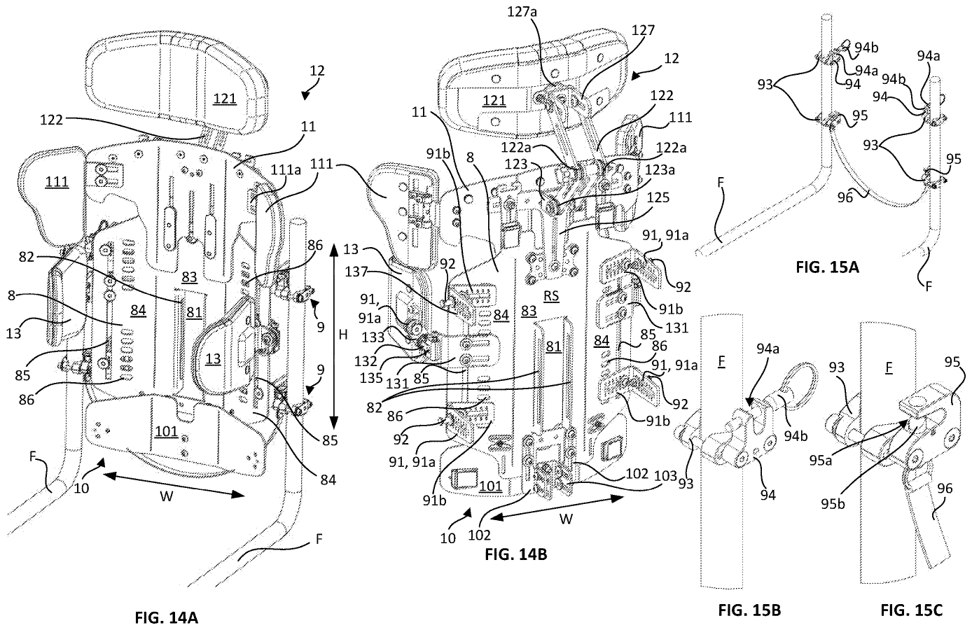

FIG. 15A-15C are views of coupling means for attaching the back support system of FIG. 14 to a wheelchair

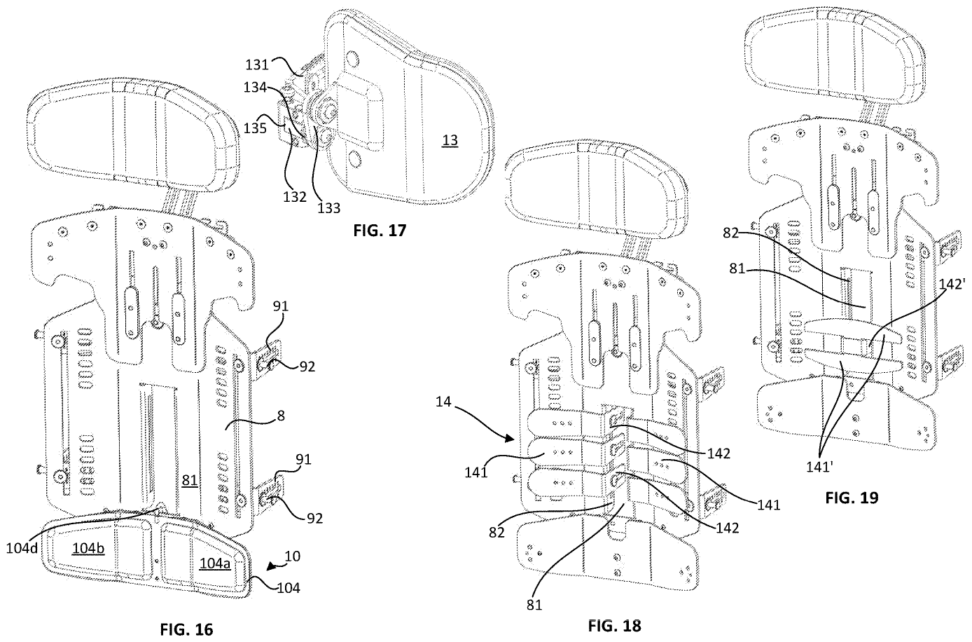

FIG. 16 is a view of the back support system of FIG. 14, with a sacral support bladder;

FIG. 17 is a view of a lateral trunk support of the back support system of FIG. 14;

FIG. 18 is a view of the back support system of FIG. 14, with a first example of backrest contouring accessories;

FIG. 19 is a view of the back support system of FIG. 14, with a second example of backrest contouring accessories;

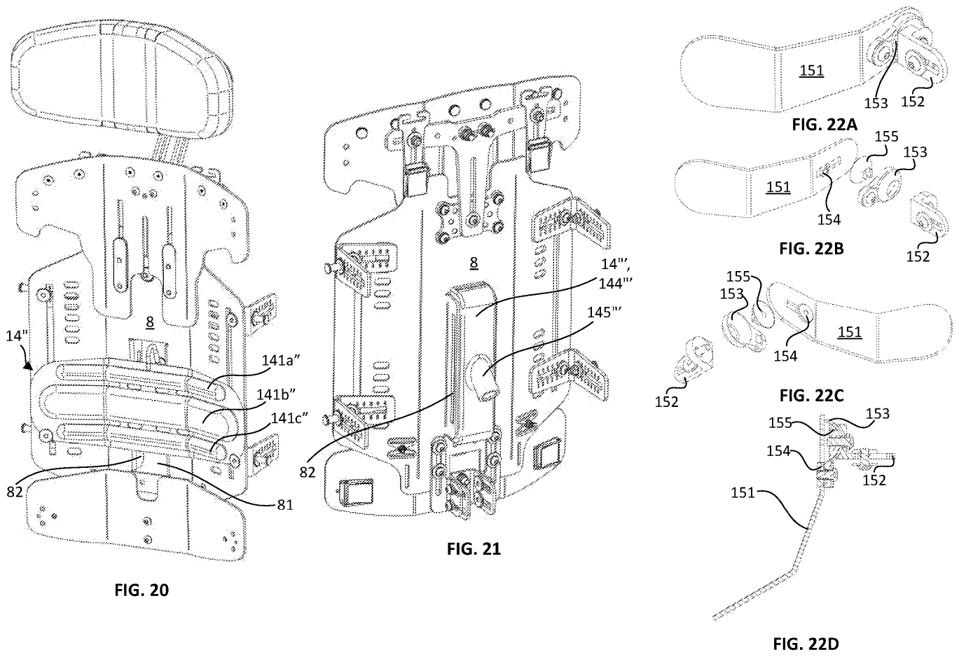

FIG. 20 is a view of the back support system of FIG. 14, with a third example of backrest contouring accessories;

FIG. 21 is a view of the back support system of FIG. 14, with a fourth example of backrest contouring accessories;

FIG. 22A-22D are views of a fifth example of a backrest contouring accessory;

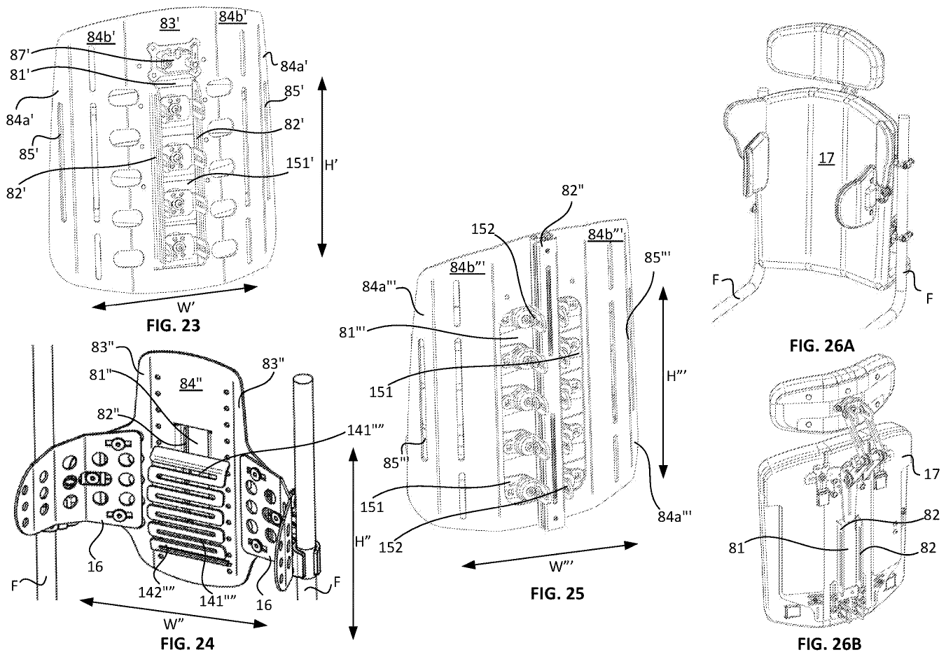

FIG. 23 is a second example of a back support system with a sixth example of backrest contour accessories;

FIG. 24 is a view of the third example of a back support system with a seventh example of a backrest contour accessory;

FIG. 25 is a view of a fourth example of a back support system with the backrest contouring accessories of FIG. 22;

FIG. 26A-26B are views of the back support system of FIG. 14 with a covering;

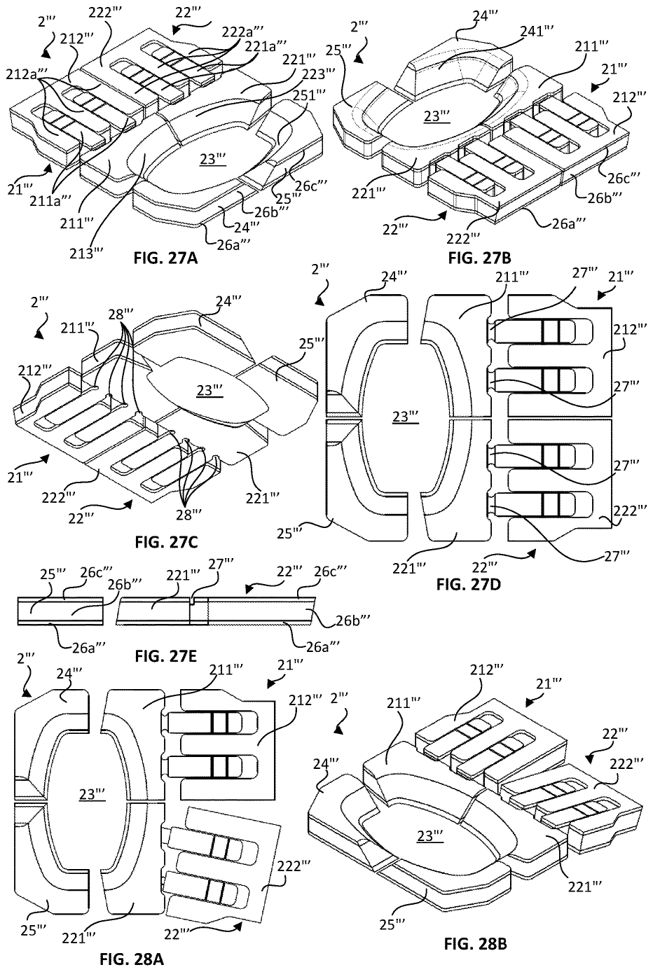

FIG. 27A-27E are views of another example of a core;

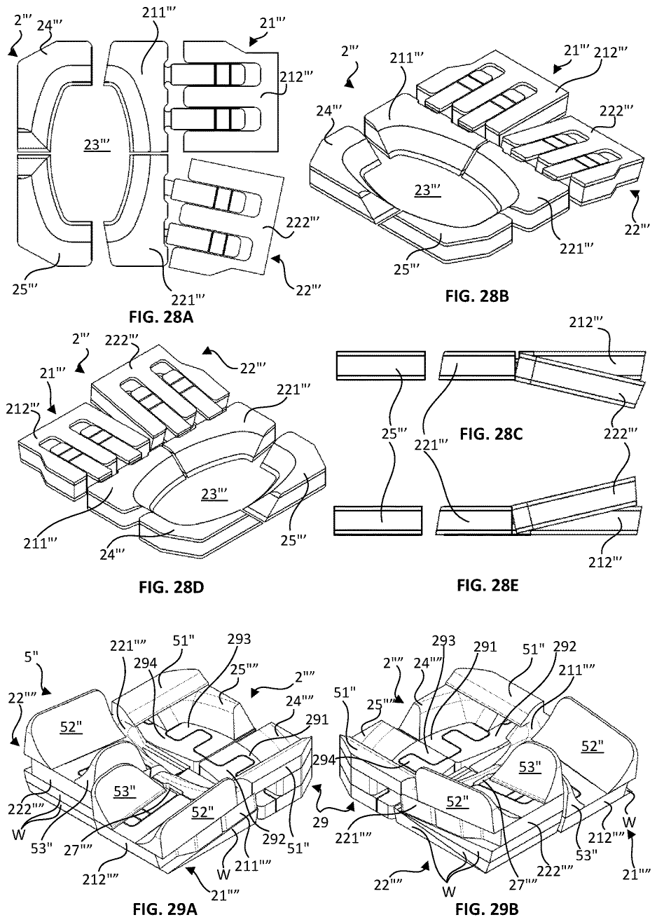

FIG. 28A-28E show the core of FIG. 27 subjected to various deformations; and

FIG. 29a-29B are views of another example of a core, with further seating cushions attached;

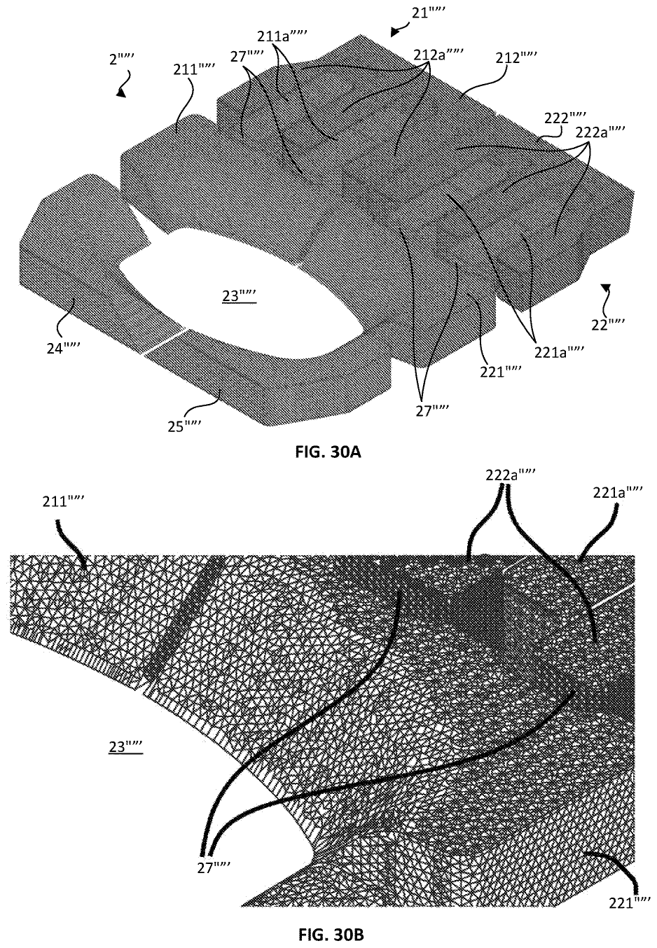

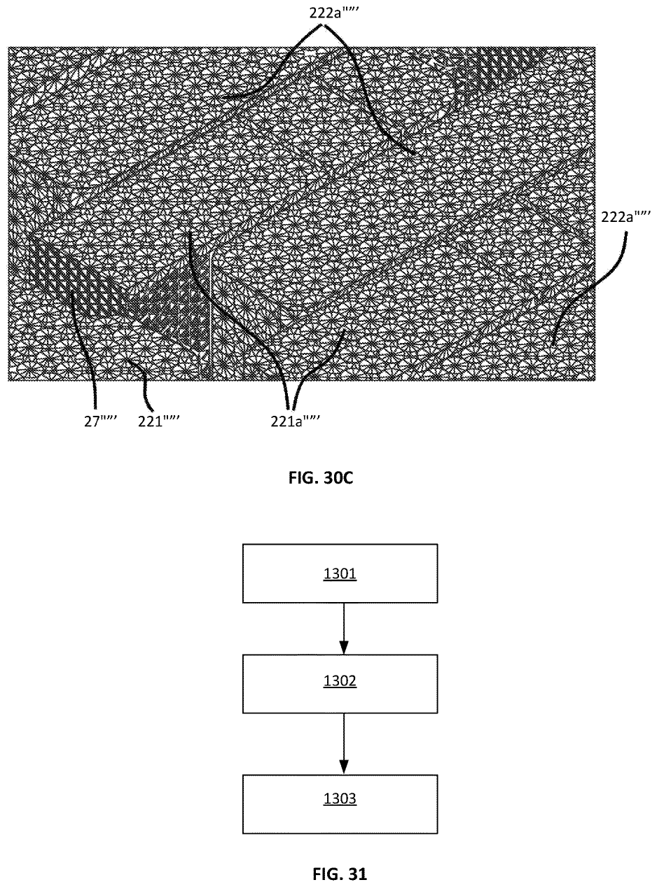

FIG. 30A-30C are views or another example of a core; and

FIG. 31 is a flow diagram showing a method of designing and producing the core of FIG. 30.

Referring now to FIG. 1 there is shown a seat system 1 for a wheelchair (not shown). In this example, the seat system 1 has a core 2, a seat pan 3, a well insert 4, seating accessories 5, and a covering 6. In this example, the seat pan 1 is releasably attached to a wheelchair frame F (which is first shown in FIG. 9) by coupling means 31, as is described in more detail subsequently. Also in this example, the core 2 is releasably attachable to the seat pan 3, for example using hook and loop fasteners or by fasteners such as screws. The seating accessories 5 are releasably attachable to the core 2, for example using hook and loop fasteners. The well insert 4 is removably receivable in a seat well 23 provided in the core 2. In this example the covering 6 is provided over the core 2, seat pan 3, well insert 4 and seating accessories 5, to provide a seating surface for a wheelchair user (not shown) to sit on. Reference is made throughout to directions such as forward, backward, rearward, upward, downward, vertical, horizontal and so on, and these refer to directions when the various parts are attached to a wheelchair and the wheelchair is located on a horizontal floor.

Referring now to FIG. 2, the core 2 is shown. FIG. 2A shows a rear isometric view and FIG. 2B shows a top view. The core 2 has a left-thigh support 21 and a right-thigh support 22. The left-thigh support 21 has an upper-thigh support part 211 and a lower-thigh support part 212. The right-thigh support 22 has an upper-thigh support part 221 and a lower-thigh support part 222. The lower-thigh support part 212 of the left-thigh support 21 is separate to the lower-thigh support part 222 of the right-thigh support 22. In this example, the upper-thigh support part 211 of the left-thigh support 21 is separate to the upper-thigh support part 221 of the right-thigh support 22. In this example, the upper-thigh support part 211, 221 of each of the left- and right-thigh supports 21, 22 has two first engagement members 211a, 221a and the lower-thigh support part 212, 222 of each of the left- and right-thigh supports 21, 22 has three second engagement members 212a, 222a. The first and second engagement members 211a, 221a, 212a, 222a are elongate in shape. The first engagement members 211a, 221a of each of the left- and right-thigh supports 21, 22 are spaced apart to provide gaps therebetween, the shape of each gap between the first engagement members 211a, 221a corresponding to a shape of a respective one of the second engagement members 212a, 222a which is received or receivable in the gap. Similarly, the second engagement members 212a, 222a of each of the left- and right-thigh supports 21, 22 are spaced apart to provide gaps therebetween, the shape of each gap between the second engagement members 212a, 222a corresponding to a shape of a respective one of the first engagement members 211a, 221a which is received or receivable in the gap. In this way, the first engagement members 211a of the upper-thigh support part 211 of the left-thigh support 21 are configured to cooperate with the second engagement members 212a of the lower-thigh support part 212 of the left-thigh support 21 in a slidable relationship such that a length of each the left-thigh support 21 is adjustable independently of the right-thigh support 22. The first engagement members 221a of the upper-thigh support part 221 of the right-thigh support 22 are configured to cooperate, e.g., to interdigitate, with the second engagement members 222a of the lower-thigh support part 222 of the right-thigh support 22 in a slidable relationship such that a length of the right-thigh support 22 is adjustable, independently of the left-thigh support 21. It will be appreciated that upper- and lower-thigh supports may instead be provided with different numbers of first and second engagement members. As used herein a “member” refers to a feature which extends from a larger structure. For example, in the context of the described seat system the engagement members 211a, 221a, 212a, 222a extend from main body portions of respective support parts 211, 221, 212, 222. The engagement members 211a, 221a, 212a, 222a extend along a longitudinal direction, which corresponds to a forwards-rearwards direction of the core 2, in use. The upper- and lower-support parts 211, 221, 212, 222 are generally flat, such that the engagement members 211a, 221a, 212a, 222a are coplanar with main bodies of their respective support parts 211, 221, 212, 222.

In this example, the upper-thigh supports 211, 221 of each of the left- and right-thigh supports 21, 22 has a curved side which defines a first part 213, and a second part 223, respectively, of a periphery of the seat well 23. The seat well 23 is for receiving a buttock-supporting well-insert 4, in use. In this example, the core 2 has a posterior support having a left part 24 and a right part 25. Each of the left and right parts 24, 25 of the posterior support has a curved side which defines a third part 241 and a fourth part 251, respectively, of the periphery of the seat well 23. The left part 24 of the posterior support has a side portion which extends in a forward direction, in use, and a rear portion, which is configured to extend partway around the rear of the user. When the left and right parts 24, 25 of the posterior support and the upper-thigh parts 211, 221 of the left- and right-thigh supports 21, 22 are located adjacent one another, the seat well 23 is generally elliptical in shape. In this example the elliptical shape of the seat well 23 has flattened ends on the major axis, the flattened ends provided by the side portions of the left and right parts 24, 25 of the posterior support. However, it will be appreciated that other shapes of seat well 23 may be provided, for example without flattened ends. The first, second, third and fourth parts 213, 223, 241, 251 of the periphery of the seat well 23 are tapered in an inward direction, relative to the seat well 23, in a downward direction, relative to the wheelchair, to provide a tapered surface for receiving corresponding tapered sides of the buttock-supporting well-insert 4.

In this example, the upper- and lower-thigh support parts 211, 212, 221, 222, and the left and right parts 24, 25 of the posterior support, are cushions, which are releasably attachable to the seat pan 3, for example using hook and loop fasteners or by fasteners extending through side walls 324, 334 of the seat pan 3, as is described subsequently. The cushions may be of any suitable type, such as a polystyrene (PS) foam, a polyurethane (PU) foam or ethylene-vinyl acetate (EVA) foam.

Referring now to FIG. 3, the core 2 is shown while attached to the seat pan 3, and with various geometric adaptations. In FIG. 3A, the core 2 is shown in an extended configuration, wherein the left- and right-thigh supports 21, 22 have an increased length beyond that shown in FIGS. 1 and 2. Advantageously, the cooperation between the first and second engagement members 212a, 222a, 211a, 221a means that the left- and right-thigh supports 21, 22 are maintained in a linear arrangement during use. More specifically, rotation of any one of the upper- and lower-thigh support parts 211, 212, 221, 222 is resisted, in use, by the engagement of the respective first and second engagement members 212a, 222a, 211a, 221a. FIG. 3B shows the core 2 in a rotated configuration, to accommodate wind sweeping of a user's legs. Also shown in FIG. 3B, the right-thigh support 22 has an increased length. As can be seen in FIG. 3B, because of the curved first and second parts 213, 223 of the periphery of the seat well 23 the periphery of the seat well 23 is still generally elliptical in shape. This means that, even when accommodating the wind swept shape of the user's legs, the well insert 4 is still securely receivable in the seat well 23. FIG. 3C shows an example wherein the left- and right-thigh supports 21, 22 are abducted and are extended. Again, the periphery of the seat well 23 is maintained in a generally elliptical shape so that the well insert 4 is still securely receivable in the seat well 23 when accommodating the abduction of the legs. These advantages are especially prevalent in paediatric seating systems because the core 2 is readily adjustable to accommodate the changing needs of the child user, for example due to the child growing.

Referring now to FIG. 4 there is shown a seat system 1′ with a second example of a core 2′. The seat pan 3, seating accessories 5 and covering 6 of this seat system 1′ are the same as those of the seat system 1 of FIG. 1. The core 2′ of this example is similar to the core 2 of the previous example, as shown in FIGS. 1-3, and similar features are denoted with the same reference numbers with a succeeding prime (′). The core 2′ of this example differs from the core 2 of the previous example in that the upper-thigh support parts 211′, 221′ have straight sides 213′, 223′ at the end of the upper-thigh support parts 211′, 221′ closest to the user's buttocks, in use, instead of curved sides 213, 223 as in the previous example. In this way, the core 2′ of this example is not intended for use with a buttock-supporting well insert. Instead, this core 2′ is used when forward movement of a user is to be prevented but when a buttock-supporting well-insert is not required, because the straight sides 213′, 223′ provide a raised edge to resist forward movement of the user. As in the previous example, the left- and right-thigh supports 21′, 22′ are extendable due to the cooperation of the first and second engagement members 211a′, 212a′, 221a′, 222a′, thereby realising the same associated advantages. In this example, each straight side 213′, 223′ is tapered in a rearward and downward direction to reduce discomfort caused by the side, to a user when seated on the core 2′. As in the core 2 of the previous example, this core 2′ is a cushion, for example made from PS foam, PU foam or EVA foam.

With reference to FIG. 5 the seat pan 3, as shown in FIGS. 1, 3 and 4, is described. FIG. 5A shows a top isometric view of the seat pan 3, FIG. 5B shows an exploded view of the seat pan 3, and FIG. 5C shows a bottom isometric view of the seat pan 3. The seat pan 3 has a left lower-thigh support plate 32, a right lower-thigh support plate 33, a main plate 34, a top plate 35, two connection members 36 and two mounting bars 37. As best shown in FIG. 5B, in which the top plate 35 and core plates 325, 335 are omitted for ease of illustration, each of the left and right lower-thigh support plates 32, 33 has a first slide pin 321, 331 which is fixed relative to the respective lower-thigh support plate 32, 33, and a second slide pin 322, 332 which is slidable in a slot 323, 333 in the respective lower-thigh support plate 32, 33. The slot 323, 333 extends in a forward-rearward direction, when the respective lower-thigh support plate 32, 33 is orientated in a forward-rearward direction. The left and right lower-thigh support plates 32, 33 each have side walls 324, 334 around a forward end thereof, for constraining the respective lower-thigh support part of the core. In this example, the side walls 324, 334 have holes extending through, for the insertion of fasteners for securing the parts of the core to the seat pan 3. The left and right lower-thigh support plates 32, 33 each have a core plate 325, 335 attached to an upper surface at the forward end thereof.

The main plate 34 has two first slots 341 extending therethrough, the first slots 341 extending in a forward direction. A first slide pin 342 extends through each one of the first slots 341 and is slidable along the respective first slot 341. The main plate 34 has two second slots 343 extending therethrough and extending in an arc shape in a generally lateral direction. A second slide pin 344 extends through each one of the second slots 343 and is slidable along the respective second slot 343. The main plate 34 has two third slots 345 extending therethrough and extending in an arc shape in a generally lateral direction. The second slide pins 344 are relocatable from the second slots 343 to the third slots 345 to accommodate longer lower-thigh support plates. The main plate 34 has two forward mounting slots 346 and two rear mounting slots 347, the mounting slots 346, 347 extending through the main plate 34 and in a forward direction. A bolt extends through each mounting slot 346, 347 such that a head of the bolt is substantially flush or below a top surface of the main plate 34. The upper surface of the main plate 34 has a raised portion 348 at the rear.

The top plate 35 has two slots 351 extending through, the slots 341 extending in a forward direction. A front edge of the top plate 35 has two recesses 352, each recess 352 extending partway along the front edge.

As best shown in FIG. 5C, each connection members 36 is elongate in shape and has a connection hole 361 proximal a first end. Each connection member 36 also has a slot 362 extending through and extending partway along the length of the connection member 36. At the second end of each connection member 36 is a downward projecting footrest connection plate 363, for attaching a footrest (not shown) to each connection member 36.

As best shown in FIG. 5B, each mounting bar 37 is tubular for receiving one of the coupling means 31 in each end. Each mounting bar 37 has a mounting pad 371 on an upper surface thereof and proximal each end, each mounting pad 371 having an internal thread. In this example each mounting bar 37 is square in cross-section.

In this example each coupling means 31 has an insert portion 311 configured to be inserted into the respective end of the respective mounting bar 37. Each insert portion 311 has a slot 311a extending partway along the length which corresponds to a hole extending through a lower surface, when in use, of the respective end of the respective mounting bar 37. Each coupling means 31 has an open-ended channel 312, which is open in a downward direction when in use. Each open-ended channel 312 is closable by a securing pin 313 extending across the width of the channel, the securing pin 313 being inserted through substantially coaxial holes in each side of the respective open-ended channel 312 to close the open-ended channel 312.

When the seat pan 3 is assembled a fastener is insertable through each slot 311a and the corresponding hole in the mounting member 37 to secure the coupling means 31 to the respective mounting bar 37. In this way, the distance between the coupling means 31 along each mounting bar 37 is adjustable to allow the seat pan 3 to be mounted to wheelchairs with different dimensions. Furthermore, the lateral position of each coupling means 31 is adjustable, for example to mount the seat pan 3 laterally offset with respect to a centreline of the wheelchair. This provides further adaptability to the seat system 1.

When the seat pan 3 is assembled the connection members 36 abut a lower surface of the main plate 34. One of the first slide pins 342 extends through the connection hole 361 in each connection member 36, and through the corresponding first slot 341 in the main plate 34. One of the second pins 344 extends through the slot 362 in each connection member 36 and through the corresponding second slot 343 (or third slot 345 if longer lower-thigh support plates 32, 33 are used) in the main plate 34. Each of the left and right lower-thigh support plates 32, 33 are in slidable contact with an upper surface of the main plate 34. The first slide pin 321, 331 of each lower-thigh support plate 32, 33, is connected to a respective one of the first slide pins 342 extending through the main plate 34. The second slide pin 322, 332 of each lower-thigh support plate 32, 33, is connected to a respective one of the second slide pins 344 extending through the main plate 34. In this way the connection members 36, main plate 34 and left and right lower-thigh support plates 32, 33 are connected together in a way in which the left and right lower-thigh support plates 32, 33 are independently movable in a forward direction and rotated about the first slide pins 321, 331, 342. The forward movement is achieved by the first slide pins 321, 331, 342 sliding along the first slots 341 in the main plate while the second slide pins 322, 332, 344 slide along the respective slot 323, 333 in the respective one of the lower-thigh support plate 32, 33 and along the slot 362 in the respective connection member 36. Rotational movement is achieved by the second slide pins 322, 332, 344 sliding along the second slots 343 (or the third slots 345 if longer lower-thigh support plates 32, 33 are used). The top plate 35 is attached to the raised portion 348 of the main plate 34 such that parts of the left and right lower-thigh support plates 32, 33 are between the main plate 34 and the top plate 35. Upper surfaces of the core plates 325, 335 of each of the left and right lower-thigh support plates 32, 33 are substantially flush with the upper surface of the top plate 35. Heads of the first slide pins 321, 331 extending through the lower-thigh support plates 32, 33 are receivable in the slots 351 of the top plate 35 such that the first slide pins 321, 331 can slide relative to the top plate 35. Heads of the second slide pins 322, 332 extending through the lower-thigh support plates 32, 33 are receivable in the recesses 352 of the top plate 35 such each second slide pin 322, 332 can slide laterally relative to the top plate 35 when the respective lower-thigh support plate 32, 33 is in a retracted position, as shown by the right lower-thigh support plate 32 in FIG. 5A. The mounting bars 37 are mounted to the main plate 34 by threadedly engaging each bolt, which extends through a respective one of the mounting slots 346, with a respective one of the mounting pads 371. The connection members 36 thereby sit atop an upper surface of a front one of the mounting bars 37, providing support for the lower-thigh supports 32, 33. The position of each mounting bar 37 in a forward direction, as well as the orientation of each mounting bar 37, is adjustable by moving each bolt along the respective mounting slot 346 in the main plate 34. This provides further adaptability to the seat system 1.

When the seat pan 3 is in use, the lower-thigh support plates 32, 33 are set to the desired forward position and orientation, relative to the main plate 34 and top plate 35, and the lower-thigh support part 212, 222, 212′, 222′ of each of the left- and right-thigh support 21, 22, 21′, 22′ of the core 2, 2′ is attached to the respective core plate 325, 335 of the respective lower-thigh support plate 32, 33 of the seat pan 3. The upper-thigh support part 213, 223, 213′, 223′ of each of the left- and right-thigh support 21, 22, 21′, 22′ of the core 2, 2′ is attached to the top plate 35 of the seat pan. When used with the core 2 of the first example, the left and right parts 24, 25 of the posterior support are also attached to the top plate 35 of the seat pan 3. The seat pan, with the core 2, 2′, is positioned on the wheelchair with the desired orientation and position, by setting the mounting bars 37 and coupling means 31 at the necessary positions. In this way, the core 2, 2′ and seat pan 3 is adaptable to the specific needs of the user.

Referring now to FIG. 6, a second example of the seat pan 3′ is shown. FIG. 6A shows a top isometric view of the seat pan 3′ and FIG. 6B shows an exploded view of the seat pan 3′. The seat pan 3′ of this example is similar to the seat pan 3 of the previous example, and similar features are denoted with the same reference numerals with a succeeding prime (′). The seat pan 3′ of this example differs from the seat pan 3 of the previous example in that each of the left and right lower-thigh support plates 32′, 33′ has a first slot 323′, 333′ and a second slot 325′ 335′ extending through the lower-thigh support plate 32′, 33′ and extending in a forward direction. Each first slot 323′ 333′ is proximal an inside edge of the respective lower-thigh support plate 32′, 33′ and each second slot 325′, 335′ is proximal an outside edge of the respective lower-thigh plate 32′, 33′. A first slide pin 322′, 332′ extends through the first slot 323′, 333′ in each lower-thigh support plate 32′, 33′ and a second slide pin 321′, 331′ extends through the second slot 325′, 335′ in each lower-thigh support plate 32′, 33′. The seat pan 3′ of this example also differs from the seat pan 3 of the previous example in that the first slide pins 342′ of the main plate 34′ are fixed in the main plate 34′ and the second slide pins 344′ of the main plate 34′ are received in a slot 343′ which extends through the main plate 34′ and extends in a forward direction, proximal a lateral side of the main plate 34′. When the seat pan 3′ of this example is assembled, each first slide pin 322′, 332′ of the lower-thigh support plate 32′, 33′ is connected to a respective one of the first slide pins 342′ of the main plate 34′, and each second slide pin 321′, 331′ of the lower-thigh support plates 32′, 33′ is connected to a respective one of the second slide pins 344′ of the main plate 34′. In this way, each of the left and right lower-thigh support plates 32′, 33′ can be independently moved forwards and backwards by the first slide pin 322′, 332′ sliding in the respective first slot 323′, 333′ in the respective lower-thigh support plate 32′, 33′, and by the second slide pin 321′, 331′, 344′ sliding in the respective second slot 325′, 335′ in the respective lower-thigh support plate 32′, 33′ and the respective slot 343′ in the main plate 34′. In this example, a top plate and core plates are not present, and connecting members are also not present.

Referring now to FIG. 7, a third example of a seat pan 3″ is shown. FIG. 7A shows a top isometric view of the seat pan 3″ and FIG. 6B shows an exploded view of the seat pan 3″. The seat pan 3″ of this example is similar to the seat pan 3′ shown in FIG. 6, and similar features are denoted with a double prime (″) instead of a prime (′). The seat pan 3″ of this example differs from the seat pan 3′ of the previous example in that there is a single lower-thigh support plate 32″, instead of separate left and right lower thigh-support plates. The lower-thigh support plate 32″ has a slot 325″ proximal each outside edge, and these slots 325″ are similar to the second slots 325′, 335′ in the left and right lower-thigh plates 32′, 33′ of the seat pan 3′ of the previous example. Accordingly, the main plate 34″ of the seat pan 3″ of this example only has slide pins 344″ which are similar to the second slide pins 344′ in the seat pan 3′ of the previous example. Therefore, whilst the left and right lower-thigh support plates 32′, 33′ of the previous example are independently movable in a forward and backward direction, the lower-thigh support plate 32″ of the seat pan 3″ of this example is a single structure and so is movable, forwards and backwards, as a single structure.

Referring now to FIG. 8, there is shown a third example of a core 2″ and an associated fourth example of a seat pan 3″, where FIG. 8A is a front perspective view and FIG. 8B is a rear perspective view. The core 2″ is this example is similar to the core 2′ shown in FIG. 4, and similar features are denoted with a succeeding double prime (″) instead of a prime (′). The core 2″ of this example differs from the core 2′ shown in FIG. 4 in that the upper- and lower-thigh support parts 211″, 212″, 221″, 222″ of the left- and right-thigh supports 21″, 22″ are provided by sheet material which is bent to provide the top and side surfaces, instead of cushions. In this example the sheet material is sheet metal, for example mild steel, but any other material may be provided such as injection moulded plastic.

The seat pan 3″ of this example is similar to the seat pan 3′ of the example shown in FIG. 6, and similar features are denoted with the same reference numeral with a succeeding triple prime (″′) instead of a prime (′). The seat pan 3″ of this example differs from the seat pan 3′ of FIG. 6 in that the main plate 34′″ does not have a raised portion and so the left and right lower-thigh support plates 32′″, 33′″ extend further rearward. Furthermore, the left and right lower-thigh support plates 32′″, 33′″ do not have side walls. The seat pan 3′″ of this example also differs in that it has upstanding mounts 349′″ extending from side edges of the main plate 34′″, at the rear of the main plate 34′″. Each upstanding mount 349′″ has three elongate slots 349a″ extending in a height direction. This seat pan 3″ also differs from previous examples in that there is left-buttock support 51 and a right-buttock support 52. Each of the left- and right-buttock supports 51, 52 has a flat support plate 511, 521 which is connected at an edge, via a hinge 512, 522, to a mounting plate 513, 523. The mounting plate 513, 523 of each of the left- and right-buttock supports 51, 52 is attachable to the respective upstanding mount 349″ of the seat pan 3′″ by inserting fasteners through holes in the mounting plate 513, 523 and through the slots 349a′″ in the respective upstanding mount 349″. In this way, the height of each of the left- and right-buttock support 51, 52 is adjustable by fixing the respective mounting plate 513, 523 at various positions along the length of the slots 349a′″ in the respective upstanding mount 349′″. Each flat support plate 511, 521 of the left- and right-buttock support 51, 52 is pivotable about the respective hinge 512, 522 to gain access to the main plate 34 underneath, for example to set the rotation of the left and right lower-thigh supports 32′″, 33′″.

Referring now to FIG. 9, attachment of the seat pan 3 to a wheelchair frame F is shown. In this example, the first example of the seat pan 3 is illustrated, but it will be appreciated that the attachment to the wheelchair frame F is the same in all of the examples, that is, with all of the coupling means 31, 31′, 31″, 31′″. Each coupling means 31 has an associated clamp 314 which is attachable to the wheelchair frame F. Each clamp 314 has two elongate parts 314a, 314b, each with a curved section for receiving a part of the circumference of the wheelchair frame F, and each with two holes at the ends, for receiving bolts 314c therein to clamp the two elongate parts together about the wheelchair frame F. Two clamps 314 are attached to the wheelchair frame F forward of the front coupling mechanisms 31, and two clamps 314 are attached to the wheelchair frame F rearward of the rear coupling mechanisms 31. Therefore, when the seat pan 3 is attached to the wheelchair frame F such that parts of the wheelchair frame F are secured in the open-ended channels 312 of the coupling means 31 by the securing pins 313, the seat pan 3 is prevented from moving forwards and backwards by abutment between each coupling means 31 and the respective clamp 314. It will be appreciated that the coupling means of the other examples of seat pan work in the same way. That is, the other coupling means have the same associated clamps.

Referring now to FIGS. 10 and 11 a second example of coupling means 71 and an associated clamp 72, is described. Each coupling means 71 and associated clamp 72 together provide a coupling mechanism, of which each seat pan 3 has four. The coupling mechanisms are shown in use with the first example of the seat pan 3 but are usable with any of the seat pan examples. As best shown in FIG. 10D, each coupling mechanism 71 has a rod 711, the rod 711 having a cylindrical section 711a at a first end and an insert section 711b at the other end. In this example the insert section 711b has a square cross-section, to correspond to an inside cross-section of the mounting bars 37, such that the insert section 711b of each rod 711 is insertable into a respective end of a mounting bar 37. Each insert section 711b has a locking cavity 711c proximal the cylindrical section 711a, and on a bottom surface of the insert section 711b when the seat pan 3 is attached to the wheelchair frame F. Each insert section 711b has an attachment slot (not shown) extending along a side thereof, the attachment slot being configured to receive a fixing means for securing the insert section 711b to a hole which extends through a side of the respective mounting bar 37. In this way, each insert section 711b is securable the respective end of the respective mounting bar 37 with adjustable lateral positioning. Accordingly, as in the previous example of coupling means 31, the coupling means 71 of this example can be adjusted to fit different widths of wheelchair frame F, as well as to adjust the lateral position of the seat pan 3 relative to the wheelchair frame F.

As in the clamp 314 associated with the coupling means 31 of the previous example, the clamp 72 of this example has two elongate parts 721a, 721b, each with a curved section for receiving a part of the circumference of the wheelchair frame F, and each with two holes at the ends, for receiving bolts 314c therein to clamp the two elongate parts together about the wheelchair frame F.

Attached to an inside one of each of the two elongate parts 721b of each clamp 72 located at the front of the wheelchair, in use, is a latch mounting plate 722. Each latch mounting plate 722 has a channel extending through and along a length thereof. The latch mounting plate 722 is attached to the inside elongate part 721b of the respective clamp 72 by inserting a fastener through a hole in the inside elongate part 721b and through the channel in the latch mounting plate 722. The height position of each latch mounting plate 722 is adjustable by changing the position of the fastener with respect to the channel in the latch mounting plate 722. Each latch mounting plate 722 has an open-ended channel 722a, the open-ended channel 722a being open in an upward direction when the clamp 72 is attached to the wheelchair frame F. A latch 723 is rotatably connected to each latch mounting plate 722. Each latch 723 has an overhang portion 723a and a sloping upper edge located such that the overhang portion 723a is located between the sloping upper edge and the rotatable connection with the latch mounting plate 723. The clamp 72 has a biasing means (not shown), which, in this example, is a spring, which biases the latch 723 into a closed position in which the overhang portion 723a at least partially closes the open-ended channel 722a of the latch mounting plate 722. Each latch 723 has a handle extending from the rotatable connection, upon which a force is applicable to rotate the latch 723 about the rotatable connection into an open configuration, in which the open-ended channel 722a of the latch mounting plate 722 is open. As best shown in FIG. 11, the latch 723 has a locking protrusion 723b, in the form of a pin or rod with a rounded end, which is configured to extend upwardly when the latch 723 is in the open configuration.

Attached to an inside one of each of the two elongate parts 721b located at the rear of the wheelchair, in use, is a hook plate 724. Each hook plate 724 has a channel extending through and along a length thereof. The hook plate 724 is attached to the inside elongate part 721b of the respective clamp 72 by inserting a fastener through the channel in the hook plate 724 and through a hole in the inside elongate part 721b of the respective clamp 72. The height position of each of the hook plate 724 is adjustable by changing the position of the fastener with respect to the channel in the hook plate 724. Each hook plate 724 has an open-ended channel 724a, the open-ended channel 724a being open in a substantially forward direction when the hook plate 724 is attached to the wheelchair frame F.

As shown in FIG. 10D, to attach the seat pan 3 to the wheelchair frame F, the cylindrical section 711a of each rear rod 711 is inserted into the open-ended channel 724a of a respective one of the hook plates 724. At this point the latches 723, at the front of the wheelchair, are in the closed configuration, and the cylindrical section 711a of each front rod 711 is moved downwards to abut the sloped edge of a respective one of the latches 723 to move the latch 723, against the force of the biasing member, into the open configuration. Once the cylindrical section 711a enters into the respective open-ended channel 722a of the latch mounting plate 722, the biasing member urges the latch 722 into the closed configuration to secure the respective cylindrical section 711a in the open-ended channel 722a of the latch mounting plate 722. In this way, the seat pan 3 is securable to the wheelchair frame F. As best shown in FIG. 11B, in order to release the seat pan 3 from the wheelchair frame F, the handle of each of the latches 723 is pushed to rotate the respective latch 723 into the open configuration. During this rotation, the respective locking protrusion 723b enters the locking cavity 711c in the insert section 711b of the respective rod 711. This interaction between the locking protrusion 723b and the locking cavity 711c secures the respective latch 723 in the open configuration, and so allows one-handed removal of the seat pan 3. When the rods 711 are removed from the open-ended channels 722a, the locking protrusion 723b becomes disengaged from the locking cavity 711c in the insert section 711b of the respective rod 711, and so the biasing member urges the respective latch 723 into the closed configuration.

Referring again to FIGS. 1 and 3, the seating accessories 5 are in the form of thigh-support wedges which are attachable to the lower-thigh support parts 212, 222 of the left and right thigh-supports 21, 22 such that the height of the wedges increases in the forwards direction. However, it will be appreciated that any suitable postural support seating accessories may be attached to the core 2, including accessories which are customisable for the user. Indeed, FIG. 12 shows a seat system 1″ which has further accessories 5″. The further accessories 5″ include lateral trochanter supports 51″ which are attachable to the left and right parts 24, 25 of the posterior support of the core 2, or to the upper-thigh support parts 211, 221 of the left and right thigh-supports 21, 22. The further accessories 5″ also include lateral thigh supports 52″ and medial thigh supports 53″ which are attached to the wedges. Otherwise, if the wedges are omitted, the lateral thigh supports 52″ and medial thigh supports 53″ are attachable to the lower-thigh support parts 212, 222 of the left and right thigh-supports 21, 22. As also shown in the seat system 1″ of FIG. 12, when the lateral trochanter supports 51″, lateral thigh supports 52″ and medial thigh supports 53″ are used, the covering 6 may be replaced with semi-tubular covering 6″ which sits between and is supported by the lateral trochanter supports 51″, lateral thigh supports 52″ and medial thigh supports 53″ and extends underneath and part way around the user's legs when the user is sitting on the seat system 1″. Otherwise, there may be no covering present. Accordingly, the seat system provides yet more adaptability to a user, to meet specific requirements both in terms of postural support needs and in terms of changing needs, for example due to a child growing.

Referring now to FIG. 13, various buttock-supporting well-inserts, referred to hereinafter as ‘well-inserts’, are shown. All of the well-inserts are generally elliptical in plan view, with flattened ends along the major axis, to cooperate with the seat well 23 of the core 2. The edges of the well-inserts taper inwardly to cooperate with the tapered sides of the seat well 23. This tapered shape furthers the advantage associated with the core 2, in that, even when the parts of the core are moved to account for the needs of a user, the cooperating tapered sides provide a robust shape which corresponds to the well-insert. FIG. 13A shows the first example of well-insert 4, which is made from any suitable material such as a foam, for example a viscoelastic foam, a gel or a bladder filled with microbeads. In a specific example, the bladder has an air outlet which allows a vacuum to be applied to the bladder when the microbeads are in a desired shape, such that the well-insert 4 can effectively be moulded to a desired shape. The well insert 4′ of FIG. 13B is of a two-part construction, having an upper layer 41′ and a lower layer 42′. The upper layer 41′ and the lower layer 42′ are made from different materials, for example the upper layer 41′ being of a lower density foam than the lower layer 42′. In another example, the upper layer 41′ is a gel and the lower layer 42′ is foam. In another example the lower layer 42′ has microbeads included in a bladder, for example with an air outlet as described earlier, and the upper layer 41′ is of any of the aforementioned materials. In another example, either or both layers 41′, 42′ are additively manufactured, to provide layers with different stiffnesses. In another layer the upper layer 41′ is a viscoelastic foam. It will be appreciated that other combinations are envisaged. The well insert 4″ of FIGS. 13C and 13D has a central channel 41″ in the top surface which extends in a forward direction across the entirety of the well-insert 4″. This well-insert 4″ also has a blind cavity 42″ extending into a bottom surface on each lateral half of the well insert 4″. The cavities 42″ are for receiving stiffeners, for example foam of a higher density that the rest of the well-insert 4″. The provision of two cavities 42″ means that different stiffnesses of stiffener can be included in each cavity 42″, to accommodate pelvic tilting of the user. Furthermore, the channel 41″ provides flexibility to the well-insert 4″ to accommodate pelvic tilting. FIG. 13E shows a well-insert 4′″ which has an internal inflatable bladder (not shown). The well insert 4′″ has an air-hose 43′″ in fluidic communication with the bladder, and a hand pump 44′″ at the end of the air-hose 43′″, for adjusting an air-pressure inside the bladder, to meet the postural support needs of the user. The well-insert 4″′ also has a releasable non-return valve 45′″ is in fluidic communication with the air hose 43′″, for selectively deflating the bladder by pressuring a button on the valve 45′″. Instead of a hand pump an electronic pump and microcontroller may be provided. FIG. 13F shows an example well-insert 4″″ which is the well-insert 4″ of FIGS. 13C and 13D, with inflatable bladders (not shown) in the cavities. Each of these inflatable bladders has an air-hose 43″″, a hand pump 44″″ and a valve 45″″ as in the example well-insert 4′″ of FIG. 13E. The provision of two inflatable bladders allows each to be inflated to a different pressure, to meet the specific postural needs of the user, for example to accommodate pelvic tilt. FIG. 13G shows a well-insert 4′″″ which is additively manufactured. This allows the well-insert 4′″″ to have any desired shape to meet the requirements for the user, such as including lattice structures or varying stiffnesses in the height, lateral or forward and backward directions.

Referring now to FIG. 14, a back support system for a wheelchair is shown. The back support system has a backrest 8. The backrest 8 has a rear surface RS configured to face away from the user, in use. The backrest 8 has a height defining a height direction H, and a width defining a width direction W. The backrest 8 is a plate, in that it can carry bending loads, having a bending stiffness. In other words, the backrest 8 is not a membrane. The backrest 8 has an aperture 81 extending therethrough, which, in this example, is an elongate aperture 81. The aperture 81 is located substantially centrally relative to the width of the backrest 8. The aperture 81 is located closer to the bottom than the top of the backrest 8 and extends along around 40% of the height of the backrest 8, in this example. However, it will be appreciated that any length of aperture 81 is envisaged. The aperture 81 has a first side and a second side which is opposite to the first side, the first side and the second side each being substantially orientated along the height direction H of the backrest 8 and the first and second sides being the longer sides of the elongate aperture 81. The backrest 8 has two attachment surfaces 82 extending from the rear surface RS of the backrest 8 and orientated along the height direction H of the backrest 8. Each attachment surface 82 extends in a rearward direction, in use. Each attachment surface 82 extends orthogonally to the rear surface RS. In this example, each attachment surface 82 is a surface of an attachment plate 82, and one of the attachment plates 82 extends from each of the first side and the second side of the elongate aperture 81. Also in this example, each attachment plate 82 has a channel extending therethrough, the channel extending along the height direction H. The attachment plates 82 are for attaching one or more backrest contouring accessories to the backrest 8 by connection to the respective channel in the attachment plate 8, as is described subsequently. In this example, the depth of each attachment plate 82 is less than or equal to half of a width of the aperture 81 and the attachment plates 82 and the remainder of the backrest are unitary. In this example, the backrest 8 has a central portion 83 through which the aperture 81 is located, and two side portions 84 which extend in a forward direction, in use, at an oblique angle to the central portion 83. In this example the angle between the side portions 84 and the central portion 83 is shallow, for example 15°, and provides an partially enclosed shape for receiving a user's back. In this example, the backrest 8 has a channel 85 and a row of spaced-apart holes 86 located in each side portion 84 of the backrest 8, and substantially aligned with the height direction H. Each channel 85 and/or row of spaced-apart holes 86 is for attaching coupling means 9 to the backrest 8, as well as for attaching one or more lateral trunk supports 13 to the backrest 8.

The backrest 8 may be made from any suitable material, for example a metal plate, metal alloy plate, mild steel plate, a plastic plate or a composite plate. However, advantageously, when the backrest 8 is made from a plate which is cut and bent to form the backrest 8, such as from metal, the attachment plates 82 and aperture 81 are easily formed by cutting the shapes of the attachment plates 82 and aperture 81 and bending the attachment plates 82 backwards to form the aperture 81.

The coupling means 9 are for releasably coupling the backrest 8 to the wheelchair frame F, as shown in FIG. 14A. There are four coupling means 9, one located proximal a top of each lateral side of the backrest 8 and one located proximal a bottom of each lateral side of the backrest 8. Each coupling means 9 has an angled bracket 91. Each angled bracket 91 has a first portion 91a at an oblique angle to a second portion 91b. Each of the first and second portions 91a, 91b of each angled bracket 91 has a channel extending through and extending partway along a length thereof. Each coupling means has a mounting rod 92 attachable to a respective one of the angled brackets 91. Each mounting rod 92 has a mounting section with a shoulder at one end, and a threaded section extending from the shoulder in the opposite direction to the mounting section. Each mounting rod 92 is configured to be attached to the respective angled bracket 91 by inserting the threaded portion through the channel in the first portion 91a, at a desired position along the first portion 91a, and then attaching a nut to the threaded section to secure the mounting rod 92 in place. Each angled bracket 91 is configured to be attached to the backrest 8 by inserting a fastener through the channel in the second portion 91b and also through one of the channels 85 in the backrest 8. In this way, the position in the height direction of each coupling means 9 is adjustable by attaching the angled bracket 91 at a desired position along the respective channel 85 in the backrest 8. Each angled bracket 91 may instead or as well be secured to one of the spaced-apart holes 86 in the backrest 8.

Referring now to FIG. 15, the parts of the coupling means 9 which are configured to be attached to the wheelchair frame F to receive the mounting rods 92, are shown. Each of these parts of the coupling means 9 include a clamp 93, which is substantially the same as the clamp 314 described with reference to FIG. 9. There are four clamps 93, one clamp 93 corresponding to each mounting rod 92 and angled bracket 91 on the backrest 8, two of the clamps 93 being attachable to one upright pole of the wheelchair frame F, and the other two clamps 93 being attachable to the other upright pole of the wheelchair frame F. The upper two clamps 93, when attached to the wheelchair frame F, each have a vertical latch 94 attached thereto. Each vertical latch 94 has an open-ended channel 94a, the open end of which faces a substantially upward direction when attached the wheelchair frame F. Each open-ended channel 94a is closable by a securing pin 94b extending across the width of the channel 94a, the securing pin 94b being inserted through substantially coaxial holes in each side of the respective open-ended channel 94a to close the open-ended channel 94a. The lower two clamps 93, when attached to the wheelchair frame F, each have a horizontal latch 95 attached thereto. Each horizontal latch 95 has an open-ended channel 95a, the open end of which faces a substantially horizontal direction when attached the wheelchair frame F. Each open-ended channel 95a is closable by a spring-loaded gate pin 95b extending across the width of the channel 95a. The gate pin 95b extends through a hole in a lower side of the respective open-ended channel 95a, and an end of the gate pin 95b abuts, or is proximal to, the other side of the open-ended channel 95a, to close the open-ended channel 95a. Each gate pin 95b has a lead-in surface, the height of which is similar to the width of the open-ended channel 95a, and which faces towards the open end of the open-ended channel 94a. The gate pin 95b is urged into the closed position, that is the position in which the gate pin 95b at least partially closes the open-ended channel 945a, by a spring (not shown). Attached to an end of each gate pin 95b which is opposite to the end which closes the open-ended channel 94a, is a pull-strap 96. In this example, the pull-strap 96 extends between both of the lower latches 95. In this way, the pull-strap 96 is configured to be moved downwards to move both gate pins 95b against biasing forces of the respective springs, to open the open-ended-channels 95a. Advantageously, this allows one-handed opening of both lower latches 95.

To assemble the backrest to the wheelchair frame F, the upper mounting rods 92, when attached to the backrest 8, are each lowered into the open-ended channel 94a of the respective upper latch 94, when the securing pin 94b is in an open configuration in which the open-ended channel 94a is open. Each lower mounting rod 92 is then pushed, horizontally, against the lead-in surface of the gate pin 95b of the respective lower latch 95, to move the gate pin 95b, against the biasing force of the spring, to an open position, thereby allowing the respective lower mounting rod 92 to enter the open-ended channel 95a. Once each lower mounting rod 92 has passed the respective gate pin 95b, the spring urges the gate pin 95b back to the closed position to secure the respective mounting rod 92 in the open-ended channel 95a. Each securing pin 94b is inserted into the respective upper latch 94 to close the respective open-ended channel 94a, before or after the lower mounting rods 92 are connected to the respective lower latches 95. In this way, the backrest 8 is secured to the wheelchair frame F. To remove the backrest 8, each securing pin 94b is removed from the respective upper latch 95, the pull-strap 96 is moved downwards to open the open-ended channels 95a of the lower latches 95, the lower mounting rods 92 are moved horizontally out of the lower latches 95 and the backrest 8 is lifted to remove the upper mounting rods 92 from the upper latches 94.

Referring again to FIG. 14, the back support system has a sacral support 10 coupled to the backrest 8. The sacral support 10 has a sacral support plate 101 with a central section and two side portions which extend in a forward direction, in use, at an oblique angle to the central portion. In this way, the shape of the sacral support plate 101 corresponds to that of the backrest 8. A part of the sacral support plate 101 is located between a part of the backrest 8 and the user, in use. The sacral support 10 has two sacral support attachment plates 102 which are attached or attachable to the sacral support plate 101 in a spaced relationship, such that a part of the backrest 8 is receivable between the sacral support attachment plates 102 and the sacral support plate 101. The sacral support attachment plates 102 each have a channel aligned in the height direction H, each corresponding to two holes in the backrest 8, for attaching each sacral support attachment plate 102 at multiple positions along the height direction H relative to the backrest 8. Each sacral support attachment plate 102 has a connection plate extending in a normal direction to the part of the sacral support attachment plate 102 which has the channel extending through, the connection plate extending in a rearward direction, in use. Each connection plate of the sacral support attachment plate 102 has two channels extending in a forward and rearward direction. The sacral support 10 has a U-shaped sacral connector 103 having a central portion and two side portions extending from either side of the central portion. The central portion of the sacral connector 103 has a channel extending in the height direction H which corresponding to two holes in the sacral support plate 101, for attaching the sacral connector 103 to the sacral support plate 101 at multiple positions along the height direction H relative to the sacral support plate 101. The side portions of the sacral connector 103 each have two channels extending in a forward and rearward direction, and corresponding to the channels in the connection plate of a corresponding one of the sacral support attachment plates 102. The sacral support 10 is assembled to the back system by attaching the sacral support attachment plates 102 to the backrest 8, attaching the sacral connector 103 to the sacral support plate 101, and then attaching the sacral connector 103 to the sacral support attachment plates 102. The initial connections between the sacral support attachment plates 102 and the backrest 8, the sacral connector 103 and the sacral support plate 101, and the sacral connector 103 and the sacral support attachment plates 102 can be made loosely so that the sacral support plate 101 can be positioned with a desired height, inclination and rotation about a vertical axis which best suits the user, and then the connections tightened. In this example, the sacral plate 101 is adjustable over a height of around 30 mm. This allows the sacral support plate 101 to be optimally positioned to meet the user's needs. In the example shown in FIG. 14, the sacral support 10 has a clasp 105 at either side, each clasp 105 for frictionally engaging with a support strap (not shown) to pass around a user's stomach. Each clasp 105 engages the strap in a strap loosening direction, such that the strap can be pulled through each clasp 105 to tighten the strap around the user, and each clasp 105 has a push lever for disengaging the clasp 105 from the strap to loosen the strap.

Referring now to FIG. 16, the back support system is shown with a sacral support bladder 104 attached to the sacral support plate 101. The sacral support bladder 104 has two inflatable parts 104a, 104b which are arranged side-by-side. An air hose 104c is fluidly coupled to the inflatable parts 104a, 104b, and at the end of the air hose 104d is a hand pump (not shown) and valve (not shown), for selectively inflating the inflatable parts 104a, 104b of the sacral bladder 104. This illustrates another advantage of the backrest 8, namely that the air hose 104c can pass through the aperture 81 in the backrest 8, and so is readily accessible for adjusting the pressure in inflatable parts 104a, 104b of the sacral bladder 104. In another example the air pressure in each inflatable part 104a, 104b of the sacral bladder 104 is independently adjustable. This is either through separate air hoses and pumps, or by a valve associated with each inflatable part 104a, 104b. In another example, instead of a hand pump there is provided an electronic pump and associated microcontroller.

Referring again to FIG. 14, the back support system has a shoulder support 11 coupled to the backrest 8. The shoulder support 11 has a shoulder support plate with a central section and two side portions which extend in a forward direction, in use, at an oblique angle to the central portion. In this way, the shape of the shoulder support plate corresponds to that of the backrest 8. A part of the shoulder support 11 is located between a part of the backrest 8 and the user, in use. The central section of the shoulder support plate 11 has two channels extending through and in the height direction H. These channels are for receiving fasteners to fix the shoulder support to the backrest 8. The height of the shoulder support 11 is therefore adjustable, relative to the backrest 8, by positioning the fasteners at various positions along the channels. In this example the shoulder support 11 is adjustable over a height of 75 mm.

Also attached to the backrest 8 is a head support system 12. The head support system 12 has a headrest 121 which is connected to the backrest 8 via an articulating arm 122. The headrest has a cushion or covering on a forward-facing side and the articulating arm 122 is attached to a rearward-facing side. The articulating arm 122 is formed of two parallel upper arm sections, each pivotably connected to a lower arm section at an indexing pivot 122a. Each indexing pivot 122a has two indexing discs located between the upper arm section and the lower arm section, the indexing discs having teeth configured to engage with the teeth of the corresponding indexing disc, for example in 10° rotational increments. In this way, the two indexing discs may be securable to one another in discrete rotational increments. A spacer is located between the two indexing pivots 122a to maintain the spacing between the upper and lower arm sections. A bolt extends through the ends of both upper arm sections, the ends of both lower arm sections, all four indexing discs and the spacer, such that, when the bolt is loosened, the teeth of the indexing discs can pass over one another to change the angle between the upper and lower arm section, and when the bolt is tightened the angle between the upper and lower arm sections is secured. Each lower am section is connected to a side portion of a U-shaped arm connector 123 at a respective indexing pivot 123a. The indexing pivots 123a located between the lower arm sections and the arm connector 123a operate in the same way to the indexing pivots 122a located between the upper and lower articulating arms, except that no spacer is present, and each indexing pivot has an associated bolt for loosening and tightening the indexing pivot 123a. However, it will be appreciated that a single bolt and spacer may be used instead of two separate bolts. The head support system 12 has a mounting plate 124. The mounting plate 124 has a channel extending in the height direction H, through which a fastener is insertable to secure the mounting plate 125 to the backrest 8. The mounting plate 125 also has two channels extending in the width direction W, for attaching harness strap clasp assemblies 126 to. Each harness strap clasp assembly 126 has a clasp, which is substantially the same as the clasps 105 on the sacral support 10, and a channel extending through and along the height direction H. Each harness strap clasp assembly 126 is securable to the mounting plate 125 at any position along the respective channel of the mounting plate 125, and at any position along the length of the channel of the harness strap clasp assembly, such that the height and lateral position of each harness strap clasp assembly 126 is adjustable relative to the backrest 8. The head support system 12 has a U-shaped headrest connector 127, which has two side portions extending from a central portion. The central portion is connected to the headrest 121 via a ball and socket joint 127a, which is the same as the rotatable connector of the backrest contouring accessory 15 of FIG. 22, as is described subsequently. Therefore, the headrest 121 is rotatable relative to the headrest connector 127. Each side portion of the headrest connector 127 has a channel extending along, in the direction to and from the central portion. Ends of each of the upper arms of the articulation arm 122 are connectable at any position along the length of the channel of the respective side portion of the headrest connector 127, such that the depth of the headrest with respect to the backrest 8 is adjustable. All of the connections in the head support system 12 provide fine control of the position of the headrest 121, allowing the position to be adapted to meet the specific needs of the user.

Attachable to each side of the shoulder support 11 is a lateral shoulder support 111. Each lateral shoulder support 111 is attachable to the shoulder support 11 via a hinge, such that the lateral shoulder support 111 is rotatable about an axis which is substantially aligned with the height direction H. Each lateral shoulder support 111 is connected to the shoulder support 11 by a mounting plate 111a which has two channels extending through and along the width direction W. Each mounting plate 111a of the lateral shoulder supports 111 is fixable to the shoulder support 11 at any position along the channels, such that the lateral position of each lateral shoulder support is adjustable.

Attachable to each side of the backrest 8 is the lateral trunk support 13, as shown in FIGS. 14 and 17. Each lateral trunk support 13 is connected, via a mounting plate 131, to a respective one of the channel 85 and/or row of spaced-apart holes 86 located in the respective side portion 84 of the backrest 8, such that the height of the trunk support 13 is adjustable. Each mounting plate 131 has two channels extending through and in the width direction W, for connecting to the channel 85 and/or row of spaced-apart holes 86 in the respective side portion 84 of the backrest 8, such that the lateral position of the trunk support 13 is adjustable. Each trunk support 13 is connected to the respective mounting plate 131 by a connecting arm. The connecting arm has a first portion 132 connected to a second portion 133 via two indexing discs 134. As in the previous example, a fastener extends through the indexing discs 134 and is loosened, to allow the toothed discs to turn relative to one another, and tightened, to secure the indexing discs 134 together in a specific rotational position. The first portion 132 is pivotably connected to the mounting plate 131 via a hinge 135, such that the first portion 132 is pivotable outwardly and inwardly in the width direction. The axis of rotation of the indexing discs 134 between the first and second portions 132, 133 of the connecting arm is perpendicular to the axis of rotation of the hinge 135. The second portion 133 of the connecting arm is pivotably mounted to a trunk plate 136, which extends in a normal direction from the trunk support 13 on a surface which faces away from the user, in use. The second portion 133 of the connecting arm is pivotably mounted to a trunk plate 136 via two indexing discs 137, and a fastener extends through the indexing discs 137 and is loosened to allow the indexing discs to turn relative to one another, and tightened, to secure the indexing discs 137 together in a specific rotational position. Accordingly, the orientation and position of each lateral trunk support 13 can be adapted to meet the specific needs of the user.

Referring now to FIGS. 18, 19, 20 and 21 there are shown four example of backrest contouring accessories 14, 14′, 14″, 14″. In the first example, shown in FIG. 18, the backrest contouring accessories 14 are rib supports, and each has a user-facing portion 141 and an attachment portion 142, which may otherwise be referred to as an accessory attachment plate, extending at an oblique angle to the user-facing portion 141. The user-facing portion 142 of each backrest contouring accessory 14 extends in just one lateral direction. In this example, the user-facing portion 141 has a first part, from which the attachment portion 142 extends, and a second part which is at an oblique angle to the first part. In this way, the shape of each backrest contouring accessory substantially corresponds to that of the backrest 8. Each attachment plate 142 has a channel extending in a direction towards and away from the user-facing portion 141, the channel for fixing each backrest contouring accessory 14 to a respective one of the attachment plates 82 of the backrest with adjustable depth, due to the channel in the attachment portion 142 of the backrest contouring accessory, and with adjustable height due to the channel in the respective attachment plate 82 of the backrest 8. In the example shown in FIG. 18 there are six backrest contouring accessories 14, three attached to each attachment plate 82 of the backrest 8, but it will be appreciated that any number may be provided. It will also be appreciated that the dimensions of each backrest contouring accessory 14 may be different such that a different number of backrest contouring accessories 14 fit in the aperture 81 of the backrest 8. The backrest contouring accessories of this example are preferably made from aluminium, and are configured to be mouldable, or bendable, to provide further adaptability to the needs of the user.

In the second example, shown in FIG. 19, the backrest contouring accessory 14′ is a lumber support and has a user-facing portion 141′ which has a top part and a bottom part, the top and bottom parts extending in both lateral directions. The top and bottom parts are connected in the centre by a waist and the backrest contouring accessory 14′ has attachment portions 142′, which may otherwise be referred to as accessory attachment plates, extending from each side of the waist, in a normal direction to the waist. The attachment portions 142′ each have a channel extending in a direction toward and away from the user-facing portion 141′. The channel in each of the attachment portions 142′ is for fixing the backrest contouring accessory 14′ to both attachment plates 82 of the backrest 8, with adjustable depth due to the channels in the attachment portions 142 of the backrest contouring accessory 14′, and with adjustable height due to the channel in each attachment plate 82 of the backrest 8.

In the third example, shown in FIG. 20, the backrest contouring accessory 14″ is a lumber support with three elongate inflatable bladders 141a″, 141b″, 141c″ extending in a lateral direction across the backrest contouring accessory 14″. There is also an air hose 143″ in fluidic communication with the inflatable bladders 141a″, 141b″, 141c″, and a hand pump (not shown) and valve (not shown). In this way the air-pressure in the backrest contouring accessory 14″ can be adjusted to provide varying lumber support to a user. Another example of this sacral bladder provides independent air pressure control of inflatable bladders 141a″, 141b″, 141c″, through separate air pumps or through a valve associated with each inflatable bladder 141a″, 141b″, 141c″. It will be appreciated that the layout and number of the inflatable bladders may be different, to accommodate different needs of the user. For example, bladders may extend along the height direction H instead. This backrest contouring accessory 14″ has attachment portions (not shown), which may otherwise be referred to as an accessory attachment plates, extending from a rear surface, which are the same as the attachment portions of the previous example, each of which is configured to be attached at various positions along a respective attachment plate 82 of the backrest 8. In the fourth example, shown in FIG. 21, the backrest contouring accessory 14″ has a bladder (not shown) filled with microbeads (not shown). The bladder has a manifold 144″ attached to a back surface, the manifold being shaped to fit into the elongate aperture 81 of the backrest 8 and to be attached, on either side, to the attachment plates 82. The manifold 144″ has an air exit passage 145″ and a valve (not shown), such that air is extractable from the bladder, when the microbeads are in a desired shape, to maintain the microbeads in the desired shape.

Referring now to FIG. 22, a fifth example of a backrest contouring accessory 15 is shown, FIG. 22A showing a view from the rear, FIG. 22B showing an exploded view from the rear, FIG. 22C showing an exploded view from the front and FIG. 22D showing a side-section view. This backrest contouring accessory 15 is a rib support, similar to that shown in FIG. 18. The backrest contouring accessory 15 has a user-facing portion 151 which has multiple sections at shallow oblique angles to one another, configured to extend part way around a torso of the user. At one end of the user-facing portion 151 there is a connection slot extending along a length direction of the backrest contouring accessory 15. The backrest contouring accessory has an accessory attachment plate 152 which is connected to the user-facing portion 151 by a rotatable connector. The rotatable connector has a first connector 153 comprising an open-topped, semi-spherical shell with a connecting portion extending laterally from a periphery of the semi-spherical shell. The rotatable connector also has a second connector 154 received or receivable in the connection slot of the user-facing portion 151. The connecting portion of the first connector 153 is connected or connectable to the second connector 154 such that the position of the first connector 153 with respect to the user-facing portion 151 is adjustable along a length of the connection slot. The rotatable connector has a third connector 155 which is semi-spherical in shape and comprises an connector extrusion protruding from an apex of the semi-spherical shape. The third connecter 155 is received or receivable inside the semi-spherical shell of the first connector 153 with the connector extrusion extending through the open-top of the semi-spherical shell. The accessory attachment plate 152 has a semi-spherical cavity in which the semi-spherical shell of the first connector 153 is received or is receivable. The connector extrusion of the third connector 155 is configured to abut an inner surface of the semi-spherical cavity of the accessory attachment plate 152, and a fastener is insertable through a hole in the semi-spherical cavity of the accessory attachment plate 152 and the connector extrusion of the third connector 155 to attach the accessory attachment plate 152, first connector 153 and third connector 155 together. In this way, the user-facing portion 151 is rotatable relative to the accessory attachment plate 152 to provide further adjustment to the backrest contouring accessory 15.

Referring now to FIG. 23 there is shown a second example of a back support system. The back support system has a backrest 8′ which is similar to the backrest 8 of the previous example, and similar features are denoted with the same reference numerals with a succeeding prime (′). The backrest 8′ of this example differs from the backrest 8 of the previous example in that each side portion has an outer part 84a′ which is at an oblique angle to an inner part 84b′, and the inner part 84b′ is at an oblique angle to the central portion 83′. This means that the backrest 8′ is configured to extend further around the user's torso. The backrest 8′ in this example has a headrest mount 87′ for receiving an arm of a headrest (not shown). In this example, each backrest contouring accessory has a user-facing portion 151′ which extends in both lateral directions, and U-shaped accessory attachment means 152′ with side portions extending from either side of a central portion. Each side portion has a channel extending through and in a direction towards and away from the central portion. Each accessory attachment means 152′ is attachable to a respective one of the attachment plates 82′ of the backrest 8′ at any position along the height direction H′. Each accessory attachment means 152′ is connected to the respective user-facing portion 151′ by the same rotatable connector in the backrest contouring accessory 15 described with reference to FIG. 22. Multiple backrest contouring accessories are provided along the length of the aperture 81′ in the backrest 8′.

Referring now to FIG. 24 there is shown a third example of a back support system. The back support system has a backrest 8″ which is similar to the backrest 8 of the first example, and similar features are denoted with the same reference numerals with a succeeding double prime (″). In this example the side portions 83″ of the backrest 8″ are shorter, in the height direction H″, than in the first example of the backrest 8, and are located substantially centrally in the height direction H″. The back support system has side connection plates 16, which are formed of four portions each at oblique angles to one another, to form a generally curved plate. Each side connection plate 16 is configured to connect to a respective side portion 83″ of the backrest 8″, and to connect to a respective upright pole of the wheelchair frame F. This back support system has a backrest contouring accessory 14″″ which has a user facing portion 141″ and two attachment means 142″. The user facing portion 141″ has a user-facing surface which is curved in a direction towards the user, in use, and is formed of a plurality of spaced apart strips. Each strip is connected at one end to a strip on one side and is connected at the other end to a strip on the other side, to form a back-and-forth path. In this way, the user-facing portion behaves like a spring, and so offers a comfortable lumber support to a user. The attachment means 142″″ are attached to each end strip, and each has two attachment plates for connection to the attachment plates 82″ of the backrest 8″.

Referring now to FIG. 25, there is shown a fourth example of a back support system. The back support system has a backrest 8″ which is the same as the backrest 8′ of FIG. 23, and as such similar features are denoted with the same reference numerals with a succeeding triple prime (″′) instead of a single prime (′), except that there are no attachment plates and there is no headrest mount. Instead, the back support system has an attachment bar 82″ which provides attachment surfaces on either side. The attachment bar 82″ is attached to the backrest 8″ such that it extends substantially centrally in the width direction W″. The attachment bar 82″ may also be used to connect to a headrest connecting arm. This back system has the backrest contouring accessories described with reference to FIG. 22, where each accessory attachment plate 152 is connected to a respective attachment surface of the attachment bar 82″.

It will be appreciated that any of the backrest contouring accessories described herein are usable with any of the backrest also described herein, and are not limited to the combinations specifically described.

Referring now to FIG. 26, the back support system is shown with a covering 17. As shown in FIG. 26A, the covering has a cushion at the front, which provides a surface for the user's back to be received against. The covering 17 covers the front facing surfaces of the back support system. As shown in FIG. 26B, the covering 17 covers the rear surfaces of the back support system but has a gap for allowing the attachment plates 82 to extend through. This allows easy access to the attachment plates 82 and to the aperture 81 for adjusting backrest contouring accessories, and for accessing air hoses. It will be appreciated that the covering 17 can be altered to fit any of the back support systems described herein, such that the attachment surfaces and aperture are accessible.

In another example the back support systems described herein are usable in or with any of the seat systems described herein, such that the seat pan and the backrest are independently attachable and detachable form the wheelchair frame F, and are independently adjustable, to provide even more adaptability to the postural support needs of the user.

With reference to FIG. 27, a variation of the core 2 shown in FIG. 2 is presented. In the embodiment of FIG. 27 the core 2″ is the similar as the core 2 of FIG. 2, and similar reference numerals are presented for similar features, with a succeeding triple prime (″′).

The core 2″ of this embodiment differs from the core 2 of FIG. 2 in that the cushion which provides the core 2″ has three layers attached to one another. The core 2″ has a first foam layer 26a″ which is at the bottom in use, a second foam layer 26b″ which is a middle layer and a third form layer 26c″ which is at the top in use. That is, the second foam layer 26a″ is sandwiched between the first and second foam layers 26a″, 26c″. In this example, the first and third foam layers 26a″, 26c″ have a higher stiffness, or elastic modulus, density and hardness than the second foam layer 26b″. Also, the first and third foam layers 26a″, 26c″ are each much thinner than the second foam layer 26b″. In the example provided the second foam layers 26b″ is approximately four times thicker than each of the first and third foam layers 26a″, 26c″. This arrangement is advantageous in that comfort is increased, because the first and third foam layers 26a″, 26c″“ distribute load evenly over the second foam layer 26b″, and so a lower density foam can be used for the second foam layer 26b″. This also means that the foam may be selected based on user weight, such that the core ”2′ does not completely compress, which may be referred to as “bottoming out”. Furthermore, the user of higher density first and third foam layers 26a″, 26c″ means that other components, such as hook and loop fasteners, can be glued to the outer surfaces of the core 2″″ to allow other foam blocks to be attached to the core 2″ to construct seat for more complex user needs. Further still, this also means that the upper and lower surfaces of the core 2″ are more resilient to damage, and so improves the longevity of the core 2″. In this example, the first and third foam layers are closed-cell Ethylene-vinyl acetate (EVA) foam. In this example the second foam layer 26b″ is open-cell Polyurethane (PU) foam. It will be appreciated that any combination of different foams may be provided for the three foam layers 26a″, 26b″, 26c″, and that the foam layers may be of different thicknesses and have different mechanical properties. Indeed, there may also be more or fewer foam layers. It will also be appreciated that whilst the entire core 2″ has the same foam layer structure in this example, different components of the core 2″ may have different structures. The core 2″ of this embodiment also differs from the core 2 of FIG. 2 in that a top channel 27″ is provided in an upper surface at a root of each first engagement member 211a″, 221a″. Each top channel 27″ extends across an entire width of the respective first engagement member 211a″, 221a″. In this example, the depth of each top channel 27″ is at least greater than the thickness of the third foam layer 26c″ and extends partway into the second foam layer 26b″, as best seen in FIG. 27E. Also in this example, side channels 28″, which are semi-circular in cross-section, are provided in each side surface at the root of each first engagement member 211a″, 221a″, as best seen in FIG. 27C. It will be appreciated that the side channels 28″ may be provided without the top channels 27″, and that the top channels 2″ may be provided without the side channels 28″. Furthermore, it will be appreciated that a layered foam core 2″ may be provided without the top or side channels, 27″, 28″ and that top and/or side channels 27″, 28″ may be provided in a core which is an unlayered foam.

As shown in FIGS. 28A-28E, the side channels 28″ and top channels 27″ allow the first engagement members 211a″, 221a″ to move side-to-side and up and down more easily. This, in turn, allows the core 2″ to be used to develop more complex shapes, in use.

Referring now to FIGS. 29A and 29B there is shown a core 2″″ according to a further example. The core 2″ of this example is the same as the core 2″ shown in FIGS. 27 and 28 with the exception that the foam is a non-layered foam. Common features between the core 2″ of this example and the core 2″ of FIGS. 27 and 28 are shown with the same reference numeral but with a quadruple prime (″″) instead of a triple prime (″′).

In this example the top surface of the core 2″″ has the further accessories 5″ shown previously in FIG. 12, attached thereto. These include lateral thigh supports 52″, medial thigh supports 53″ and lateral trochanter supports 51″. Also in this example, an extending base panel 29 is provided beneath the left and right parts 24″, 25″ of the posterior support of the core 2″. In this way, the base panel 29 provides a buttock-supporting base panel. That is, in use, the base panel 29 may be provided between the left and right parts 24″″, 25″ of the posterior support of the core 2″″ and a seat pan. The base panel 29 has a left-rear part 291, a left-front part 292, a right-rear part 293 and a right-front part 294. The left-rear part 291 and the right-rear part 293 each has three third engagement members and the left-front part 292 and the right-front part 294 each has two fourth engagement members. The third engagement members extend in a forward direction, in use. The fourth engagement members extend in a rearward direction, in use. The third and fourth engagement members are elongate in shape. The third engagement members of each of the left-rear part 291 and the right-rear part 293 are spaced apart to provide gaps therebetween, the shape of each gap between the third engagement members corresponding to a shape of a respective one of the fourth engagement members which is received or receivable in the gap. Similarly, the fourth engagement members of each of the left-front part 292 and the right-front part 294 are spaced apart to provide gaps therebetween, the shape of each gap between the fourth engagement members corresponding to a shape of a respective one of the third engagement members which is received or receivable in the gap. In this way, the third engagement members are configured to cooperate, e.g., to interdigitate, with the fourth engagement members in a slidable relationship, such that a length of each side of the base panel 29 is adjustable. In this way, the length, in a forward to rearward direction, of the seat well, is adjustable. This is beneficial both for accommodating different sizes of user, but also to accommodate different buttock seating positions. It will be appreciated that the base panel 29 may instead be provided with different numbers of third and fourth engagement members.

In the examples of FIGS. 29A and 29B the thigh supports 21″″, 22″ are shown with different levels of tilting, and these are merely by way of example of possible positions of the thigh supports 21″″, 22″″. These tilts are achieved using wedges W, which may be layered to provide this tilting. For example, the left thigh support 21″″ is tilted downwards by placing a wedge W underneath the thigh support, with a thicker side of the wedge W located near to the seat well 23″″. The right thigh support 22″″ is tilted upwards by placing one wedge W in the same orientation as underneath the left thigh support 21″″, and then two more wedges W placed in the opposite orientation, as best shown in FIG. 29B. As discussed previously, the channels 27″″ enable this tilting movement to be achieved with less resistance from the foam material. In this example, the base panel 29 and the wedges W are a foam material, for example the same foam material as used in any of the cores. It will be appreciated that the base panel 29 may be used with cores of previous examples. Similarly, the wedges W may be used with cores of previous examples, albeit with greater resistance to tilting in cores without channels.

Referring now to FIG. 30, there is shown a core 2′″″′ which is the same core 2′″ of FIGS. 27 and 28, with the exception that the core 2″″′ of this embodiment is formed of a lattice structure. Features of the core 2″″′ of this embodiment which are similar to features of the core 2″ of FIGS. 27 and 28 have the same reference numerals with a quintuple prime (″″′) instead of a triple prime (″′). The lattice structure is formed of struts connected together, at each end, by nodes. This is best shown in FIGS. 30B and 30C. The lattice structure may improve airflow through the core 2″″′, which is beneficial for controlling the temperature of the core 2″″′. The lattice structure may also have different density and/or stiffness at different locations, to account for a pressure distribution applied to the core 2″″′ by the user. Preferably the core is 3D printed, or additively manufactured, using a plastic material, for example elastomeric polyurethan (EPU) or silicone. It will be appreciated that the density and/or elastic modulus are bulk properties of the lattice structure, not accounting for gaps or spaces in the lattice structure. For example, these may be the properties of a cube of lattice structure which contains multiple nodes and struts. The density and/or stiffness may vary in any direction. That is, the density and/or stiffness may vary through the thickness of the core 2″″′, in a forward to rearward direction, and/or in a lateral direction. The density and/or stiffness may also be different for each part of the core 2″″′. For example, either of the lower thigh support 222″″′. 212″″′ may have a different density or stiffness to either upper thigh support 221″″′, 211″″′. Indeed, the different parts of the core 2″″′ may be produced using different plastics materials and/or different designs of lattice structure.

Referring now to FIG. 31, there is shown a method of designing the core 2″″′ of FIG. 30 to be bespoke to a user. In step 3101 the postural support needs of the user are determined by determining a pressure distribution map which will be applied to the core 2″″′, by the user, in use. In step 1302 the lattice structure is then designed to alleviate pressure concentrations, to more evenly distribute the pressure over the core 2″″′. The core 2″″″′ is then 3D printed, at step 1303, using this designed lattice structure.

It will be appreciated that a lattice structure may be used to produce the core of any other embodiment. A lattice structure may be used to only produce one or more part of each core, the other parts being made using a foam materials. The seat well insert may also be produced using a lattice structure, similarly to that shown in FIG. 13G. In another embodiment, a core similar to the core 2″″′ of FIG. 30 is provided, without engagement members. In this embodiment, the upper- and lower-thigh support parts of the left- and right-thigh supports are movable relative to one another to increase the length of the respective thigh support, and a block of support material, which may also be lattice material, is insertable into the gaps.

It will be appreciated by those skilled in the art that several variations to the aforementioned embodiments are envisaged without departing from the scope of the invention. For example, where channels are disclosed for attaching parts together, these may be replaced by rows of spaced apart holes. By way of another example, the back support system may only have one attachment surface extending from the rear surface thereof, for example along a side of the aperture. It will also be appreciated by those skilled in the art that any number of combinations of the aforementioned features and/or those shown in the appended drawings provide clear advantages over the prior art and are therefore within the scope of the invention described herein.

1. A seat system for a wheelchair, the seat system comprising:
a left-thigh support comprising an upper-thigh support part and a lower-thigh support part; and
a right-thigh support comprising an upper-thigh support part and a lower-thigh support part;
wherein the lower-thigh support part of the left-thigh support is separate to the lower-thigh support part of the right-thigh support, and either the upper-thigh support part or the lower-thigh support part of each of the left- and right-thigh supports comprises one or more first engagement members and the other of the upper-thigh support part or the lower-thigh support part of each of the left- and right-thigh supports comprises two or more second engagement members, each of the first engagement members being received or receivable between two of the two or more second engagement members such that the one or more first engagement members and the two or more second engagement members are configured to cooperate with one another in a slidable relationship, such that a length of each of the left- and right-thigh supports is adjustable; and
wherein each of the first engagement members are received or receivable between two of the two or more second engagement members such that the first and second engagement members are configured to interdigitate with one another.

2. A seat system according to claim 1, wherein the one or more first engagement members are elongate in shape and the two or more second engagement members are elongate in shape, and optionally wherein the one or more first engagement members are coplanar with a part of the respective support part from which they extend and the two or more second engagement members are coplanar with a part of the respective support part from which they extend.

3. (canceled)

4. (canceled)

5. A seat system according to claim 1, wherein the one or more first engagement members is two or more first engagement members and wherein the two or more second engagement members is three or more second engagement members, wherein each of the first engagement members is received or receivable between two of the second engagement members and one of the second engagement members is received or receivable between two of the first engagement members.

6. A seat system according to claim 1, wherein the upper-thigh support of each of the left- and right-thigh supports comprises the one or more, or two or more, first engagement member/s, and wherein the lower-thigh support of each of the left- and right-thigh supports comprises the two or more, or three or more, second engagement members, and optionally wherein each of the one or more, or two or more, first engagement member comprises a channel at a root thereof, the channel extending across a width, and being located across a top surface, of the respective engagement member.

7. (canceled)

8. A seat system according claim 1, wherein the upper-thigh support part of the left-thigh support is separate to the upper-thigh support part of the right-thigh support, and the upper-thigh support part of each of the left- and right-thigh supports comprises a curved side which defines a first and second part, respectively, of a periphery of a seat well, the seat well being configured to receive a buttock-supporting well-insert, in use, and optionally wherein the curved side of the upper-thigh support part of each of the left and right-thigh support is tapered toward the centre of the seat well in a downward direction, in use.

9. (canceled)

10. A seat system according to claim 8, comprising a posterior support, the posterior support comprising a curved side which defines a third part of the periphery of the seat well, and optionally wherein the posterior support comprises a left part and a right part, each of the left and right parts of the posterior support comprising a curved side which defines the third part and a fourth part, respectively, of the periphery of the seat well.

11. (canceled)

12. A seat system according to claim 10, wherein the upper-thigh support part and the lower-thigh support part of each of the left- and right-thigh supports, and the posterior support, comprise, or are, cushions, and optionally wherein the upper-thigh support part and the lower-thigh support part of each of the left- and right-thigh supports, and the posterior support, comprise a plurality of layers of cushion material, the layers stacked in a vertical direction, and each layer of cushion material having a different density.

13. (canceled)

14. A seat system according to claim 10, wherein the upper-thigh support part and the lower-thigh support part of each of the left- and right-thigh supports, and the posterior support, are formed of a lattice structure, and/or the curved side or sides of the posterior support is tapered toward the centre of the seat well in a downward direction, in use.

15. (canceled)

16. A seat system according to claim 10, comprising one or more lateral trochanter support parts attached or attachable to the posterior support and/or to the upper-thigh support parts, and/or comprising one or more lateral thigh support parts attached or attachable to the lower-thigh support parts.

17. A seat system according claim 10, comprising a buttock-supporting well-insert.

18. A seat system according to claim 17, wherein the buttock-supporting well insert is one of, or any combination of, a foam cushion, e.g., a viscoelastic foam cushion, a gel cushion, an additively manufactured porous structure and a polymeric lattice structure.

19. A seat system according to claim 17, wherein the buttock-supporting well-insert comprises an inflatable bladder, an air-hose in fluidic communication with the bladder, and a valve in fluidic communication with the air hose for selectively inflating or deflating the bladder, and optionally wherein the buttock-supporting well-insert comprises a left inflatable bladder, a right inflatable bladder, a left air-hose in fluidic communication with the left inflatable bladder, a right air-hose in fluidic communication with the right inflatable bladder, and a valve in fluidic communication with each of the left and right air-hoses for selectively inflating and deflating the respective bladder.

20. (canceled)

21. A seat system according to claim 17, wherein the buttock-supporting well-insert comprises a bladder which includes, for example is substantially filled with, microbeads, the buttock-supporting well-insert comprising a valve in fluidic communication with the bladder for selectively evacuating air from the bladder, for example to hold the bladder under a vacuum pressure.

22. A seat system according to claim 1, wherein the engagement members of each upper-thigh support part are located on a first side of the upper-thigh support part, and wherein a second side of each upper-thigh support part, which is opposite to the first side, is tapered in a direction away from the first side and in a downward direction, when in use on the wheelchair, and optionally wherein the seat system comprises a left-buttock support and a right-buttock support, the left- and right-buttock supports being located rearward of the left- and right-thigh supports, in use, wherein the height and/or orientation, relative to the left- and right-thigh supports, of each of the left- and right-buttock supports is independently adjustable, in use.

23. (canceled)

24. A seat system according to claim 1, wherein the upper-thigh support part of each of the left- and right-thigh supports, and the lower-thigh support part of each of the left- and right-thigh supports, comprises, or is, a cushion.

25. A seat system according to claim 1, comprising a seat pan to which the upper-thigh support part and the lower-thigh support part of each of the left- and right-thigh supports are attached or attachable.

26. A seat system according to claim 25, wherein the seat pan comprises a left lower-thigh support plate, a right lower-thigh support plate and a main support plate, the left and right lower-thigh support plates being movably mounted to the main support plate such that the orientation and the position in the forward direction, when in use, of each of the left and right lower-thigh support plates is independently adjustable relative to the main support plate, and wherein the lower-thigh support parts of each of the left- and right-thigh supports are attached or attachable to the respective left and right lower-thigh support plate, and optionally wherein the upper-thigh support parts are attached or attachable to the main support plate.

27. (canceled)

28. A seat system according to claim 26, wherein the seat pan comprises coupling means for releasably coupling the seat pan to a wheelchair, the coupling means comprising four coupling mechanisms, each coupling mechanism being independently adjustable in a height direction to adjust any number of the height, inclination and lateral tilt of the seat pan relative to the wheelchair, in use.

29. A seat system according to claim 28, wherein the coupling means comprises two front rods and two rear rods, each front rod extending in a respective lateral direction from the seat pan, and each rear rod extending in a respective lateral direction from the seat pan, the coupling means also comprising two front clamps and two rear clamps, the front and rear clamps being attached or attachable to a frame of the wheelchair, each of the rear clamps comprising an overhang for receiving the rear rods extending from the seat pan, and each of the front clamps comprising a latch for releasably securing the front rods to the front clamps, and optionally wherein the latch of each of the front clamps has an open configuration whereby the respective front rod is insertable into and removable from the latch, and a closed configuration whereby the respective front rod is securable in the latch, wherein each rod comprises a locking cavity along a side thereof, and wherein each latch comprises:
a biasing member which is configured to urge the latch into the closed configuration; and
a locking protrusion protruding from the latch, the locking protrusion being configured to enter into the locking cavity of the respective front rod when the latch is rotated into the open configuration, to secure the latch in the open configuration against a biasing force of the biasing member.

30. (canceled)

31. A seat system according to claim 25, comprising a backrest which is releasably attachable to the wheelchair independently of the seat pan.
